(19) United States
(12) Patent Application Publication
(10) Pub. No.: US 2026/0105399 A1
(43) Pub. Date: Apr. 16, 2026

(54) ASSET MANAGEMENT SYSTEM AND ASSET MANAGEMENT METHOD

(71) Applicant: Hitachi, Ltd., Tokyo (JP)

(72) Inventors: Hiroki TSUYUMOTO, Tokyo (JP); Yuuichi OGAWA, Tokyo (JP)

(21) Appl. No.: 19/354,288

(22) Filed: Oct. 9, 2025

(30) Foreign Application Priority Data
Jul. 29, 2025 (JP) 2025-126250
Oct. 11, 2024 (JP) 2024-179425

(51) Int. Cl. G06Q 10/0637

(52) U.S. Cl. CPC G06Q 10/0637

(57) ABSTRACT

Asset management system includes a memory; and a processor. The memory stores asset case relation information in which each registered asset is associated with a case realized using the asset, and case information in which sales are recorded for each of the cases. The processor is configured to: set any one asset as a target asset; extract, for the target asset, a related case that is a case realized using the target asset with reference to the asset case relation information; calculate, for the target asset, a case contribution degree indicating a degree of contribution of the target asset in each of the related cases; and specify sales of the related case with reference to the case information, and calculate a business contribution degree indicating a degree of contribution of the target asset with respect to business based on the case contribution degree and the sales of the related case.

### CROSS REFERENCE TO RELATED APPLICATION

This application relates to and claims the benefit of priority from Japanese Patent Application number 2024-179425, filed on October 11, 2024, and Japanese Patent Application number 2025-126250, filed July 29, 2025, their entire disclosure of which is incorporated herein by reference.

### BACKGROUND

The present disclosure relates to a technique for managing assets created in business activities.

There are attempts to manage and utilize various types of knowledge including use cases, solutions, products, services, and system architectures created in business activities in companies and the like as assets by an information system. In asset management, it is required to appropriately evaluate a value of an asset in order to promote registration of the asset in a system or support utilization of the asset registered in the system.

PCT International Publication No. 2023/223482 discloses a method of evaluating an asset. In the method of PCT International Publication No. 2023/223482, an asset value calculation unit targets each of a plurality of business processes, and calculates an evaluation of an asset to be evaluated based on an evaluation axis for evaluating an asset value in a target business process. A contribution degree calculation unit calculates an asset contribution degree indicating a degree of contribution of an asset to be evaluated to an organizational goal by integrating the evaluations of assets calculated for one or more business processes for realizing the business strategy set to achieve the organizational goal.

### SUMMARY

In the method of PCT International Publication No. 2023/223482, the degree of contribution of an asset to an organizational goal is calculated by integrating evaluations of assets calculated based on the evaluation axis in a business process for realizing a business strategy. The evaluation value of the asset calculated by the method of PCT International Publication No. 2023/223482 can support investment decision, but is not suitable for promoting asset reuse.

One object of the present disclosure is to provide a technique for supporting promotion of use of a registered asset.

An asset management system according to an aspect included in the present disclosure includes a memory; and a processor, in which the memory stores asset case relation information in which each registered asset is associated with a case realized using the asset, and case information in which sales are recorded for each of the cases, and the processor is configured to:

set any one asset as a target asset; extract, for the target asset, a related case that is a case realized using the target asset with reference to the asset case relation information; calculate, for the target asset, a case contribution degree indicating a degree of contribution of the target asset in each of the related cases; and specify sales of the related case with reference to the case information, and calculate a business contribution degree indicating a degree of contribution of the target asset with respect to business based on the case contribution degree and the sales of the related case.

An asset management method performed by an asset management system including a memory and a processor, in which the memory stores asset case relation information in which each registered asset is associated with a case realized using the asset, and case information in which sales are recorded for each of the cases, and in a case where any one asset is set as a target asset, the asset management method includes, by the processor, a step of extracting, for the target asset, a related case that is a case realized using the target asset with reference to the asset case relation information, a step of calculating, for the target asset, a case contribution degree indicating a degree of contribution of the target asset in each of the related cases, and a step of specifying sales of the related case with reference to the case information, and calculating a business contribution degree indicating a degree of contribution of the target asset with respect to business based on the case contribution degree and the sales of the related case.

According to an aspect included in the present disclosure, it is possible to provide an asset management system and an asset management method capable of supporting promotion of use of a registered asset.

### BRIEF DESCRIPTION OF THE DRAWINGS

FIG. 2 is a conceptual diagram illustrating a configuration example of an asset table according to the first embodiment;

FIG. 3 is a conceptual diagram illustrating a configuration example of an asset case relation table according to the first embodiment;

FIG. 4 is a conceptual diagram illustrating a configuration example of a case table according to the first embodiment;

FIG. 5 is a conceptual diagram illustrating a configuration example of an RFP requirement relation table according to the first embodiment;

FIG. 6 is a flowchart illustrating output processing of a business contribution degree according to the first embodiment;

FIG. 7 is a flowchart illustrating calculation processing of a case contribution degree according to the first embodiment;

FIG. 8 is a conceptual diagram illustrating an output example of an asset search result according to the first embodiment;

FIG. 9 is a conceptual diagram illustrating another output example of the asset search result (in detail) according to the first embodiment;

FIG. 10 is a block diagram illustrating a hardware configuration example of an asset management server, a case management server, and an information processing apparatus according to the first embodiment;

FIG. 11 is a block diagram illustrating a configuration example of an asset management system according to a second embodiment;

FIG. 12 is a conceptual diagram illustrating a configuration example of a case table according to the second embodiment;

FIG. 13 is a flowchart illustrating output processing of a business contribution degree according to the second embodiment;

FIG. 14 is a conceptual diagram illustrating an output example of an asset search result (detail) according to the second embodiment;

FIG. 15 is a block diagram illustrating a configuration example of an asset management system according to a third embodiment;

FIG. 16 is a conceptual diagram illustrating a configuration example of an asset table according to the third embodiment;

FIG. 17 is a conceptual diagram illustrating a configuration example of a user table according to the third embodiment;

FIG. 18 is a conceptual diagram illustrating a configuration example of an asset-user relation table according to the third embodiment;

FIG. 19 is a flowchart illustrating output processing of an owner business contribution degree according to the third embodiment;

FIG. 20 is a conceptual diagram illustrating an output example of an asset search result according to the third embodiment; and

FIG. 21 is a conceptual diagram illustrating an output example of an asset search result (detail) according to the third embodiment.

### DETAILED DESCRIPTION OF THE EMBODIMENT

Hereinafter, an embodiment of the present invention will be described with reference to the accompanying drawings.

FIG. 1 is a block diagram illustrating a configuration example of an asset management system according to the first embodiment.

An asset management system 1 includes an asset management server 10, a case management server 20, and an information processing apparatus 30. The asset management server 10, the case management server 20, and the information processing apparatus 30 may be integrated. For example, the asset management server 10 and the case management server 20 may be integrated as one server, or the server and the information processing apparatus 30 may be integrated.

The asset management server 10 includes a processor and a memory. The memory stores an asset DB 11. The asset DB 11 includes an asset table 111 and an asset case relation table 112. An example of a hardware configuration of the asset management server 10 will be described later.

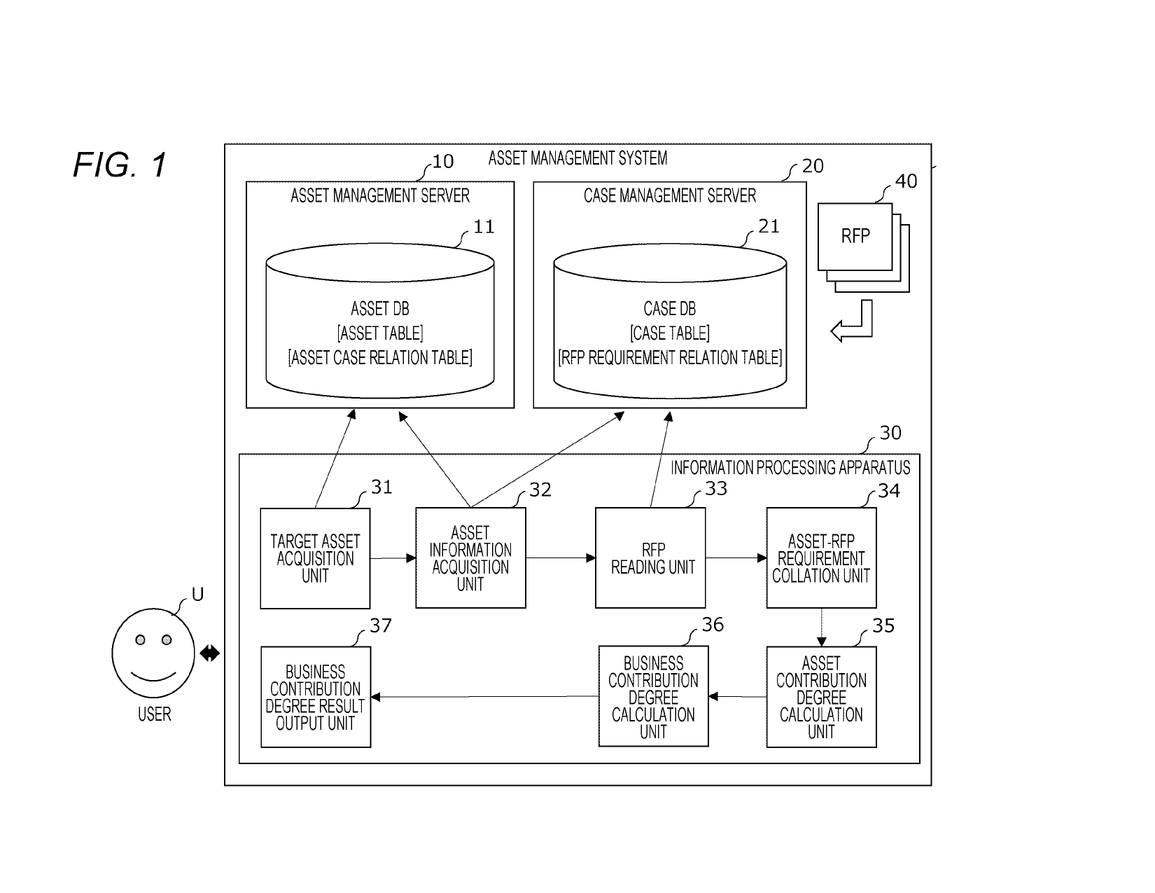

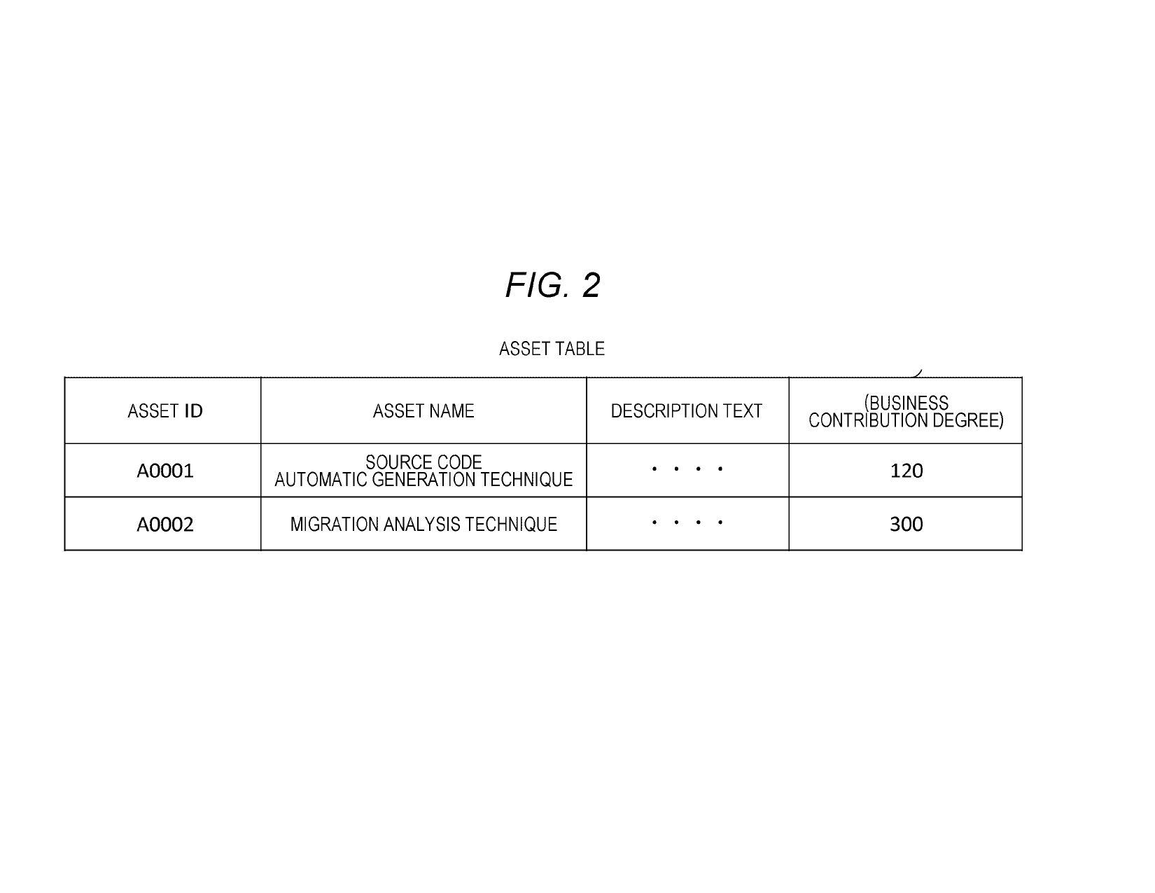

FIG. 2 is a conceptual diagram illustrating a configuration example of the asset table according to the first embodiment. FIG. 3 is a conceptual diagram illustrating a configuration example of the asset case relation table according to the first embodiment.

The asset table 111 includes, as information items (columns), an asset ID, an asset name, a description text, and a business contribution degree. The asset table 111 may have other information items. The asset ID is an identifier that can uniquely identify an asset. The asset name is a name of an asset. The description text is text information describing the content of the asset. The business contribution degree will be described later. The business contribution degree may be a value calculated in advance and registered in the asset table 111, or may be calculated in real time in response to a request of a user and be registered in the asset table 111.

The asset case relation table 112 includes, as information items, an association ID, an asset ID, a case ID, and a case contribution degree. The asset case relation table 112 may include other information items. The association ID is an identifier that can uniquely identify a combination of an asset and a case in a case where the asset uniquely specified by an asset ID is associated with the case uniquely specified by a case ID. The asset ID is similar to that in the asset table 111. The case ID is similar to that in the case table 211 which will be described later. The case contribution degree will be described later. The case contribution degree may be a value calculated in advance and registered in the asset case relation table 112, or may be calculated in real time in response to a request of a user and be registered in the asset case relation table 112.

The asset case relation table 112 corresponds to asset case relation information in which each registered asset is associated with a case realized using the asset.

The case management server 20 includes a processor and a memory. The memory stores a case DB 21. The case DB 21 includes a case table 211 and an RFP requirement relation table 212. An example of a hardware configuration of the case management server 20 will be described later.

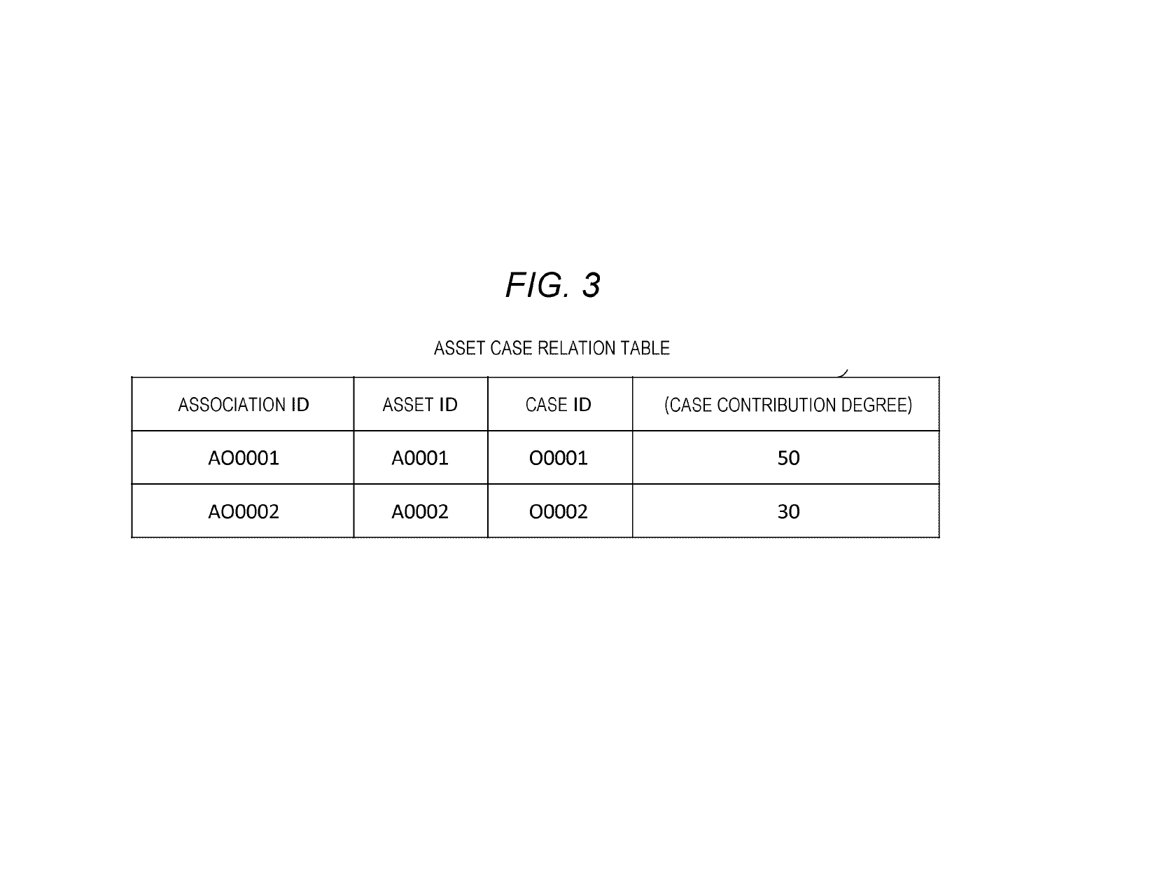

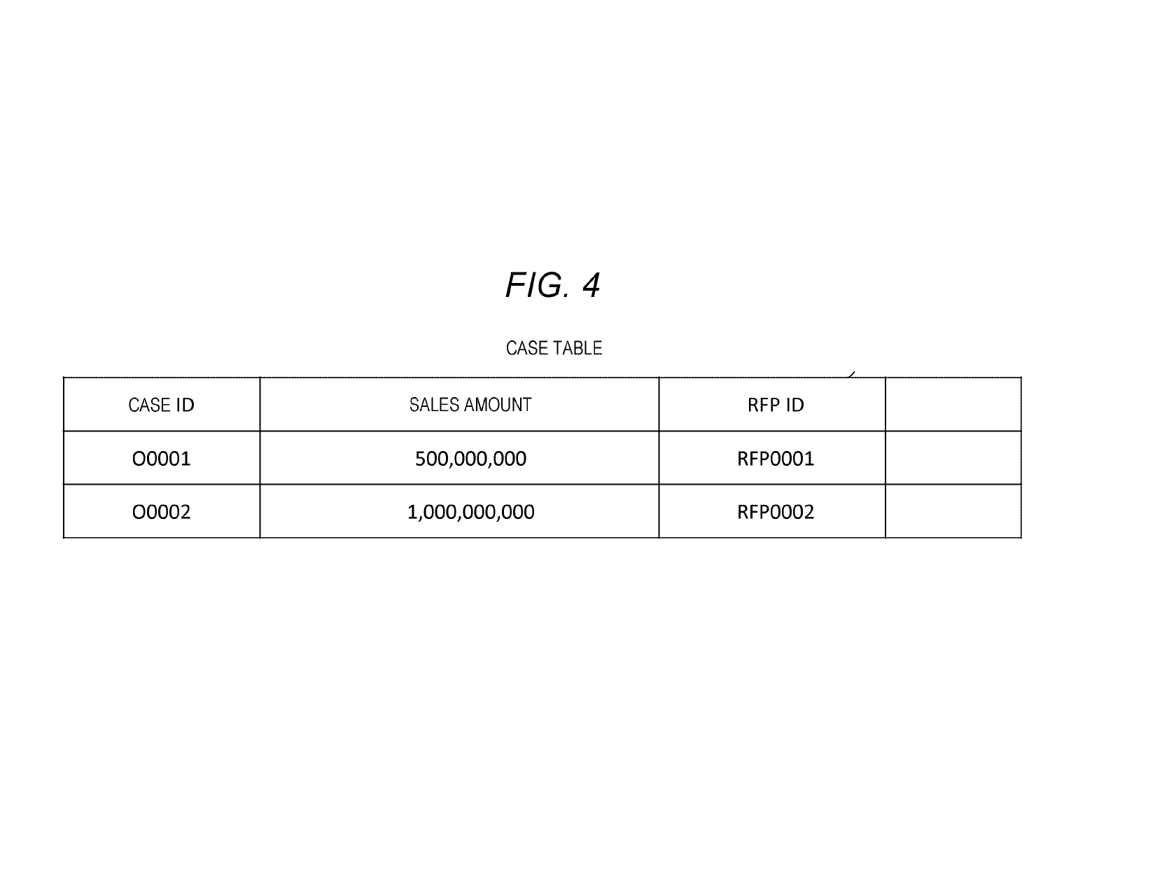

FIG. 4 is a conceptual diagram illustrating a configuration example of the case table according to the first embodiment. FIG. 5 is a conceptual diagram illustrating a configuration example of the RFP requirement relation table according to the first embodiment.

The case table 211 includes, as information items, a case ID, a sales amount, and an RFP ID. The case table 211 may include other information items. The case ID is an identifier that can uniquely identify a case. The sales amount is the sales amount for the case. The RFP ID is an identifier that can uniquely identify an RFP 40 illustrated in FIG. 1. An RFP means a proposal request form. The proposal request form is an example of a case-related document.

The RFP requirement relation table 212 includes, as information items, a requirement ID, a description text, an evaluation value, and an RFP ID. The RFP requirement relation table 212 may have other information items. The requirement ID is an identifier that can uniquely identify a requirement. The requirement description text is information describing the requirement by text in a case-related document. The evaluation value will be described later. The RFP ID is similar to that in the case table 211.

The processor of the asset management system 1 extracts a requirement and a requirement description text describing the requirement from the proposal request form, and registers the requirement and the requirement description text in the requirement-related information in association with each other. The proposal request form corresponds to the RFP 40, and the requirement-related information corresponds to the RFP requirement relation table 212.

The case table 211 corresponds to case information in which sales are recorded for each case.

Description will be made again with reference to FIG. 1. The information processing apparatus 30 includes a processor and a memory. The memory stores an asset management program and various types of data necessary for processing. An example of a hardware configuration of the information processing apparatus 30 will be described later.

The processor of the information processing apparatus 30 loads and executes the asset management program from the memory, thereby implementing the functions of a target asset acquisition unit 31, an asset information acquisition unit 32, an RFP reading unit 33, an asset-RFP requirement collation unit 34, an asset contribution degree calculation unit 35, a business contribution degree calculation unit 36, and a business contribution degree result output unit 37.

The target asset acquisition unit 31 has a function of acquiring any one asset as a target asset. The target asset acquisition unit 31 may acquire one or more assets as target assets.

The asset information acquisition unit 32 has a function of acquiring a case to which an asset is applied. The RFP reading unit 33 has a function of acquiring a requirement of the RFP 40 of a case applied to the asset. The RFP means a proposal request form of a target case indicated by a customer.

The asset-RFP requirement collation unit 34 has a function of matching the requirement of the RFP 40 with registration information of the asset and calculating a relevance degree of the asset to the requirement.

The asset contribution degree calculation unit 35 has a function of calculating a case contribution degree of an asset. A method of calculating the case contribution degree will be described later.

The business contribution degree calculation unit 36 has a function of calculating a business contribution degree of an asset. The business contribution degree is a value indicating a degree of contribution made by the target asset to business. An algorithm for calculating the business contribution degree will be described later.

The business contribution degree result output unit 37 has a function of outputting the business contribution degree as one piece of information of each asset searched by a user.

For example, a user U accesses the asset management system 1 having the above-described configuration. The user U is, for example, an integrator. The user U designates an asset whose information is desired to be confirmed as a target asset. Then, as described later, information including a business contribution degree related to the target asset can be browsed.

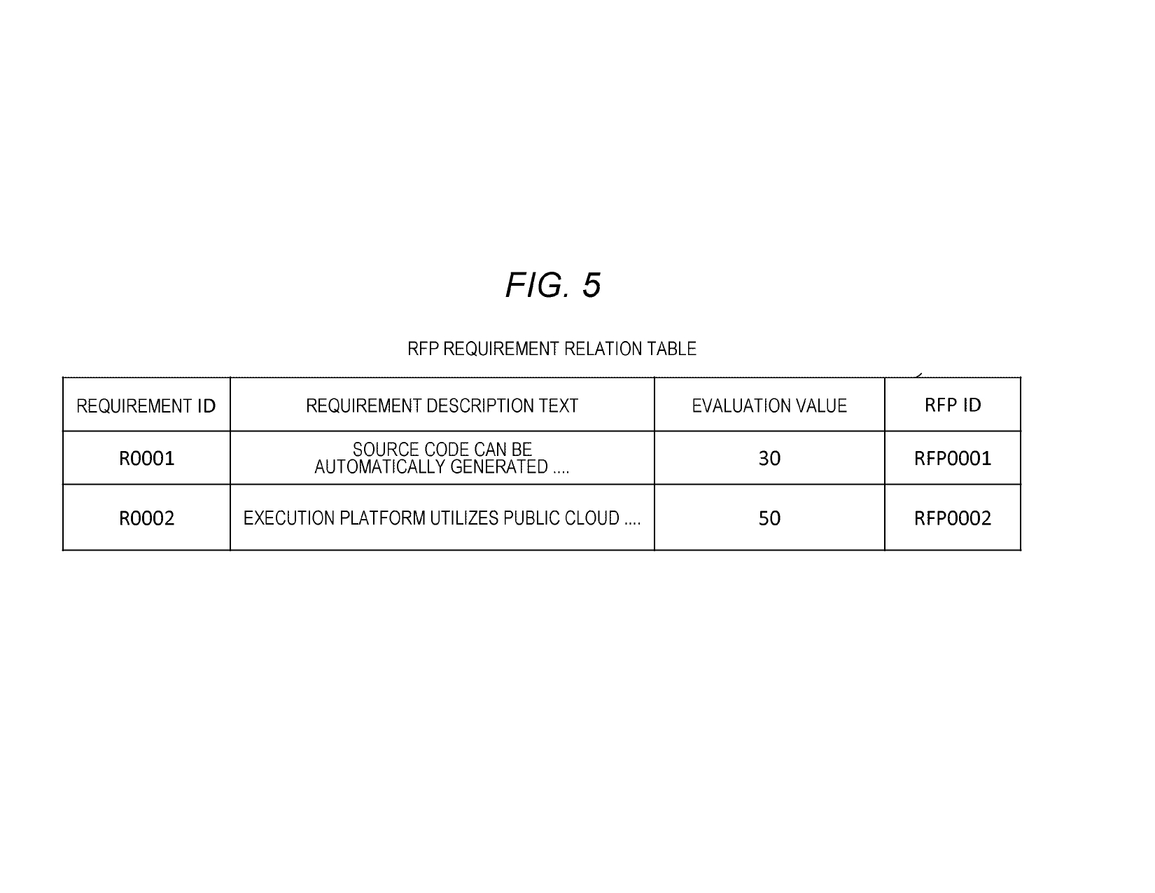

FIG. 6 is a flowchart illustrating output processing of the business contribution degree according to the first embodiment.

The information processing apparatus 30 acquires a reference request of “business contribution degree” of a target asset from the user U (St101). The target asset acquisition unit 31 acquires an asset requested from the user U as the target asset.

The asset information acquisition unit 32 acquires an asset ID of the target asset and acquires a list of cases to which the target asset is applied (St102). The asset information acquisition unit 32 acquires a list of cases with reference to the asset table 111 and the asset case relation table 112. That is, the information processing apparatus 30 extracts a related case that is a case realized using the target asset, for the target asset with reference to the asset case relation information.

The information processing apparatus 30 determines whether or not the case contribution degree of the target asset has been calculated for all cases on the list (St103). In a case where the case contribution degree of the target asset has been calculated for all the cases on the list (St103: YES), the processing proceeds to Step St105. In a case where the case contribution degree of the target asset has not been calculated for all the cases on the list (St103: NO), the processing proceeds to Step St104.

In Step St104, the asset contribution degree calculation unit 35 calculates a case contribution degree of the target asset with respect to the target case. That is, for the target asset, the information processing apparatus 30 calculates the case contribution degree indicating a degree of contribution of the target asset in each of the related cases.

In Step St105, the business contribution degree calculation unit 36 calculates the business contribution degree of the target asset.

The business contribution degree result output unit 37 outputs the business contribution degree of the target asset (St106).

### Calculation Algorithm of Business Contribution Degree

The business contribution degree calculated by the business contribution degree calculation unit 36 in Step St105 may be calculated by, for example, a calculation algorithm as follows.

The business contribution degree calculation unit 36 specifies the sales of the related case that is the case realized using the target asset, with reference to the case table 211, that is, case information. The business contribution degree calculation unit 36 calculates the business contribution degree indicating the degree of contribution with respect to the business by the target asset based on the case contribution degree of the related case and the sales.

The business contribution degree may be calculated, for example, by adding up the product of the case contribution degree and the sales for all related cases. That is, the business contribution degree calculation unit 36 sets, as the business contribution degree, a total value of values obtained by multiplying the case contribution degree of each of the related cases by the sales.

### Calculation Timing of Business Contribution Degree

The business contribution degree calculation unit 36 may receive a user operation of designating an asset and requesting reference to information of the designated asset, and calculate a business contribution degree of the target asset. The business contribution degree result output unit 37 presents the calculated business contribution degree to the user U. As described above, in a case where the business contribution degree is dynamically calculated after receiving the request from the user U, it is possible to calculate the latest contribution degree based on the registered latest information and present the latest contribution degree.

The business contribution degree calculation unit 36 may calculate the business contribution degree of each of the assets in advance and record the business contribution degree in the memory. The business contribution degree calculation unit 36 may receive a user operation of designating an asset and requesting reference to information of the designated asset, and read the business contribution degree of the target asset from the memory. The business contribution degree result output unit 37 presents the read business contribution degree to the user U. As described above, when the business contribution degree is calculated in advance and stored in the memory, it is possible to quickly present the business contribution degree in response to the request for reference.

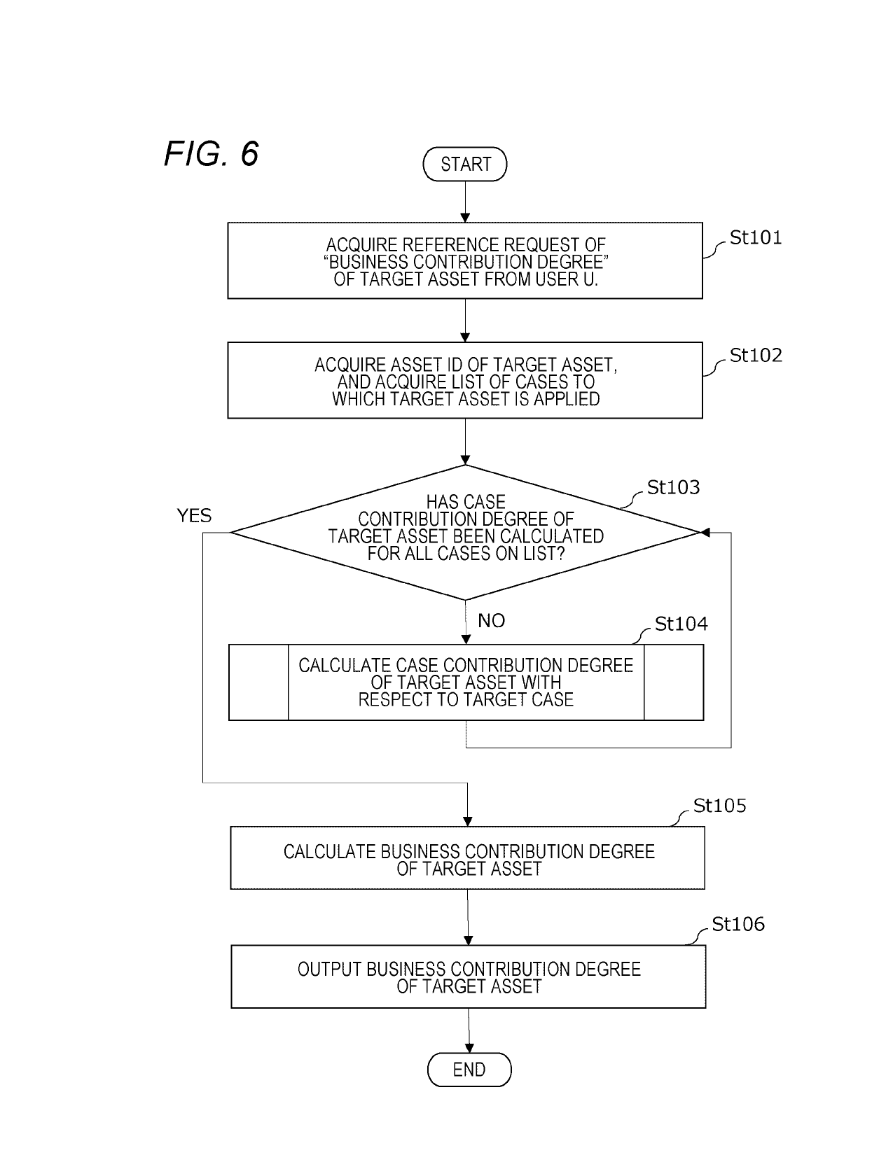

FIG. 7 is a flowchart illustrating calculation processing of the case contribution degree according to the first embodiment.

The RFP reading unit 33 acquires the RFP ID of the target case and acquires a list of requirements included in the RFP (St201).

The information processing apparatus 30 determines whether or not the requirement asset relevance degree has been calculated for all the requirements on the list of requirements included in the RFP (St202). In a case where the requirement asset relevance degree has been calculated for all the requirements on the list (St202: YES), the processing proceeds to Step St204. In a case where the requirement asset relevance degree has not been calculated for all the requirements on the list (St202: NO), the processing proceeds to Step St203.

The asset-RFP requirement collation unit 34 matches the requirement of the RFP with registration information of the asset and calculates a relevance degree of the asset to a target requirement (St203).

In Step St204, the asset contribution degree calculation unit 35 calculates the case contribution degree of the target asset.

### Calculation Algorithm of Case Contribution Degree

The case contribution degree calculated by the asset contribution degree calculation unit 35 in Step St204 may be calculated by, for example, a calculation algorithm as follows.

First, for each asset, the memory stores: asset information in which an asset description text describing the asset by text is recorded; and requirement-related information in which each requirement included in each case-related document of a case is associated with a requirement description text describing the requirement by text in the case-related document. The asset information corresponds to the asset table 111 illustrated in FIG. 2. The requirement-related information corresponds to the RFP requirement relation table 212 illustrated in FIG. 5.

The processor extracts a related case requirement that is a requirement included in the case-related document of the related case, with reference to the requirement-related information.

With reference to the asset information and the requirement-related information, the processor calculates, for each of the related case requirements, a requirement asset relevance degree indicating a degree of relevance between the case and the asset based on a similarity degree between the requirement description text of the related case requirement and the asset description text of the target asset.

The processor specifies, as a related case-related requirement, a requirement of which the requirement asset relevance degree exceeds a predetermined threshold value among the related case requirements. The processor calculates the case contribution degree of the related case in consideration of the related case-related requirement among the related case requirements.

### First Calculation Method of Case Contribution Degree

The processor may calculate a ratio of the number of related case-related requirements with respect to the number of related case requirements as the case contribution degree. For example, when there are ten related case requirements and there are six related case-related requirements of which a requirement asset relevance degree exceeds 0.5 that is a predetermined threshold value among the ten related case requirements, the case contribution degree is 6/10=0.6.

### Second Calculation Method of Case Contribution Degree

The processor may calculate the case contribution degree in consideration of an evaluation value of each requirement. The requirement-related information further associates each requirement included in the case-related document of each case with an evaluation value indicating evaluation for the requirement. This evaluation value corresponds to the evaluation value in the RFP requirement relation table 212 illustrated in FIG. 5.

With reference to the requirement-related information, the processor calculates the case contribution degree in consideration of the related case requirement and the evaluation value thereof, and the related case-related requirement and the evaluation value thereof.

More specifically, for example, the processor calculates the ratio of the total value of the evaluation values of the related case-related requirements with respect to the total value of the evaluation values of the related case requirements, as the case contribution degree.

For example, it is assumed that there are five requirements of Requirement 1 to Requirement 5 as related case requirements. The requirement asset relevance degree of Requirement 1 is 0.66. The requirement asset relevance degree of Requirement 2 is 0.23. The requirement asset relevance degree of Requirement 3 is 0.45. The requirement asset relevance degree of Requirement 4 is 0.71. The requirement asset relevance degree of Requirement 5 is 0.52. The processor specifies, as a related case-related requirement, a requirement of which the requirement asset relevance degree exceeds a predetermined threshold value among the related case requirements. In a case where the predetermined threshold value is set to 0.5, Requirement 1, Requirement 4, and Requirement 5, of which the requirement asset relevance degree exceeds 0.6, are related case-related requirements.

Referring to the RFP requirement relation table 212, the evaluation values of Requirements 1 to 5 were 30, 10, 25, 15, and 20, respectively. In this case, the evaluation values of Requirements 1 to 5 are added up to 30+10+25+15+20=100. That is, the total value of the evaluation values of the related case requirements is 100.

On the other hand, since the related case-related requirements are Requirement 1, Requirement 4, and Requirement 5, the total value of the evaluation values of the related case-related requirements is 30+15+20=65.

For example, the processor calculates the ratio of the total value 65 of the evaluation values of the related case-related requirements with respect to the total value 100 of the evaluation values of the related case requirements, that is, 65/100=0.65, as the case contribution degree.

### Word Designation by User

The memory may store asset information that enables word search for an asset name and a description text for each of the registered assets, with one or both of the asset name and the description text. The user U inputs a search word related to an asset desired to be searched for by the user U to a user terminal.

The processor of the asset management system 1 performs matching between an asset name or a description text which is an information item of the asset table 111 and a search word designated by the user, and extracts a list of matched assets. The processor presents the list of assets corresponding to the word designated by the user from the asset information to the user in this manner, for example.

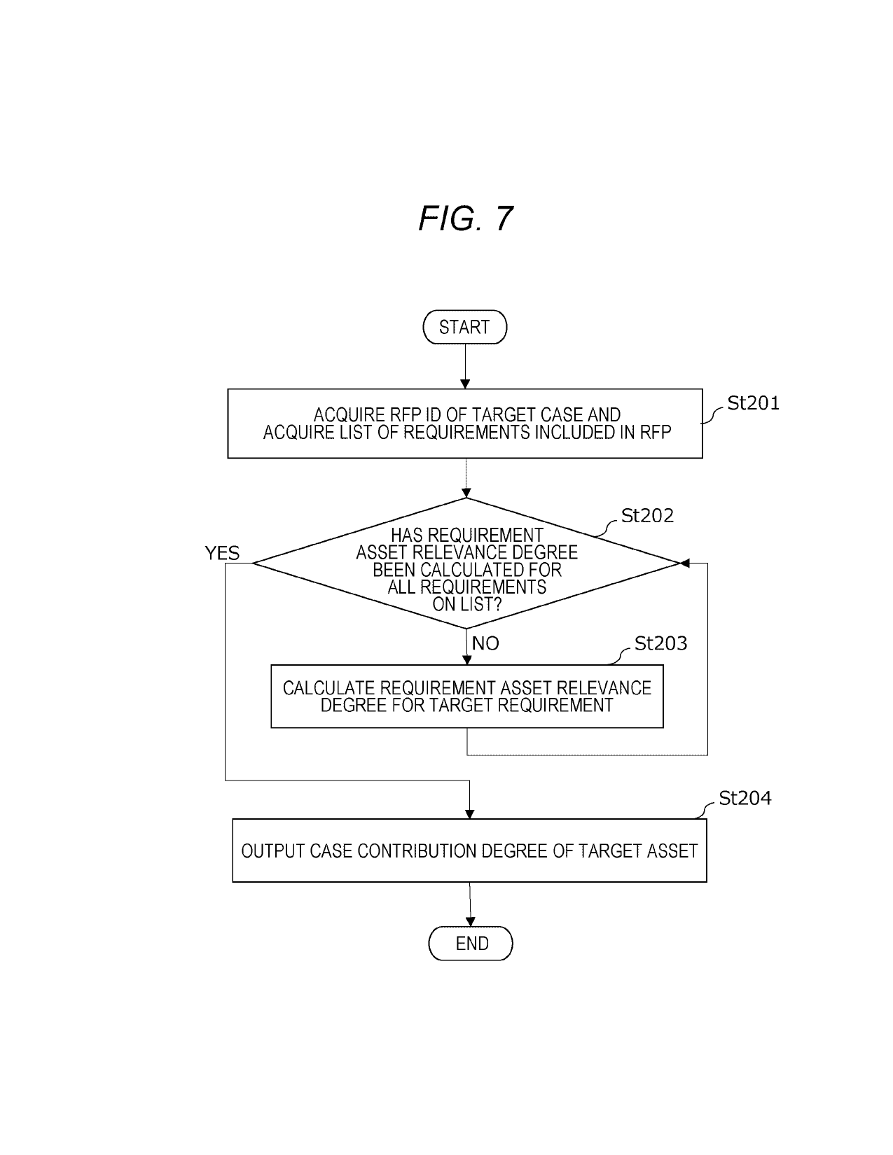

FIG. 8 is a conceptual diagram illustrating an output example of an asset search result according to the first embodiment.

The user U transmits a reference request of “business contribution degree” of the target asset to the asset management system 1 via a computer such as a user terminal. As a result, an asset search result is output to a display device D11 included in the computer such as the user terminal.

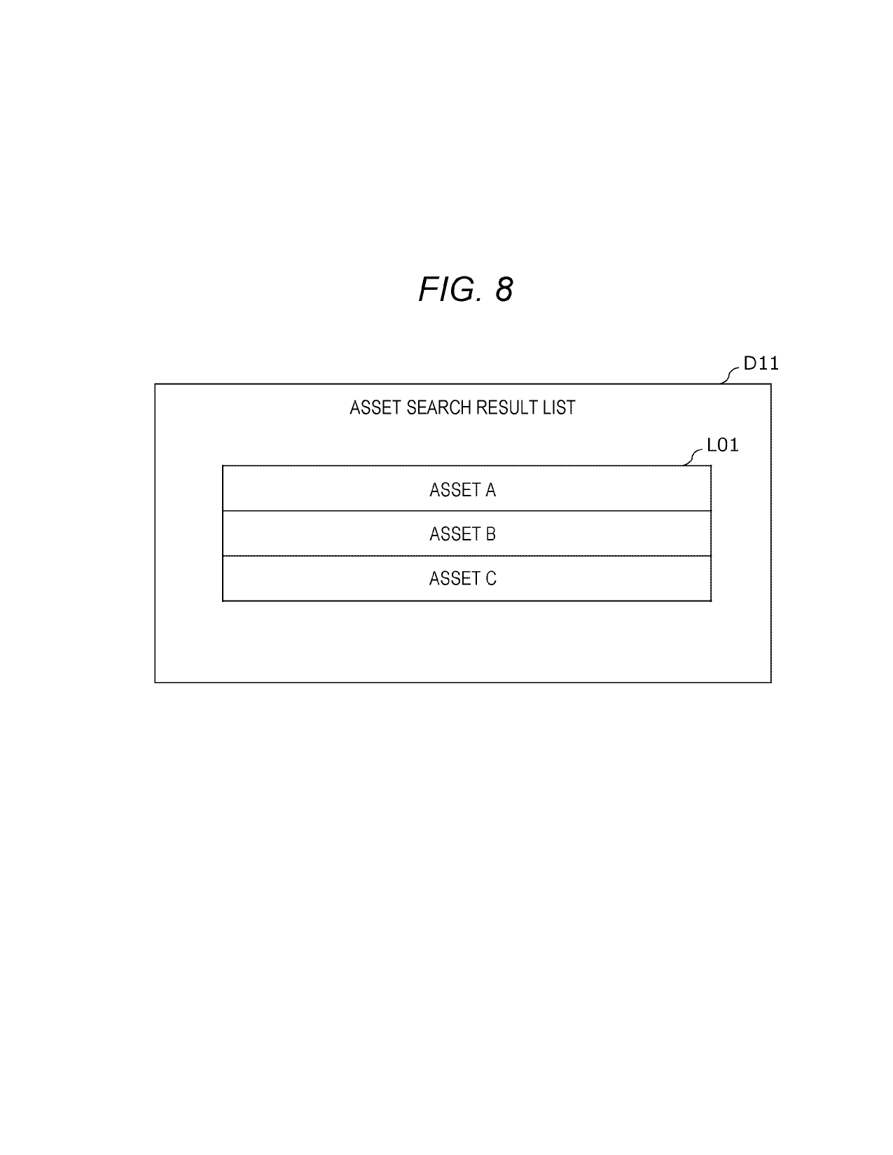

What is displayed on the display device D11 as the asset search result is a list L01 of the corresponding assets obtained by searching the asset table with the asset name and the description text. When the user U selects an asset region displayed in the list L01 by tapping or the like, the screen transitions to a display screen illustrated in FIG. 9.

FIG. 9 is a conceptual diagram illustrating another output example of the asset search result (in detail) according to the first embodiment.

When the user U selects an asset B in the display state of FIG. 8, more detailed search results illustrated in FIG. 9 are displayed on the display device D11.

A detailed list L02 of the assets B selected by the user U is displayed on the display device D11. The detailed list L02 includes basic information, detailed information, and the business contribution degree as information items. The basic information and the detailed information may be information registered in the asset table 111. The business contribution degree of the asset B may be calculated in advance and stored in the memory of the asset management system 1. The business contribution degree of the asset B may be dynamically calculated when the user U selects the asset B in FIG. 8.

The display device D11 displays a case list L03 using the asset B. The case list L03 includes, as information items, an application case, sales, and the case contribution degree.

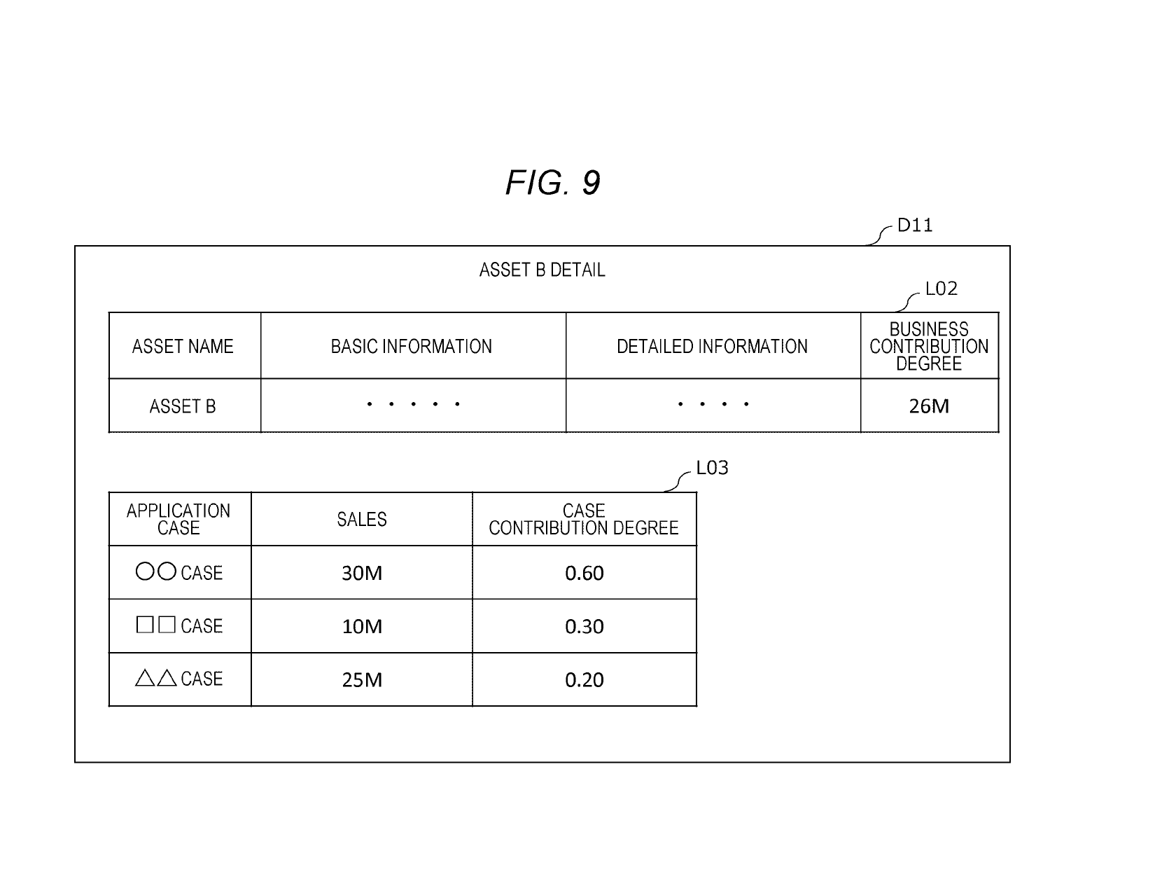

FIG. 10 is a block diagram illustrating a hardware configuration example of the asset management server, the case management server, and the information processing apparatus.

The asset management server 10, the case management server 20, and the information processing apparatus 30 are configured by a computer, for example. A computer 50 includes a processor 51, a memory 52, an auxiliary storage device 53, a communication interface 54, a medium interface 55, and an input/output device 56.

The processor 51 includes, for example, a central processing unit (CPU), a micro processing unit (MPU), a graphics processing unit (GPU), a field-programmable gate array (FPGA), or the like. The processor 51 implements various functions by reading and executing programs stored in the memory 52 or the auxiliary storage device 53.

The auxiliary storage device 53 may be, for example, a hard disk, an SSD, or the like. The auxiliary storage device 53 stores programs executed by the processor 51 and various types of data. An external storage medium 57 may be disposed outside the computer 50. The external storage medium 57 may be communicably connected to the computer 50. The external storage medium 57 stores programs executed by the processor 51 and various types of data.

The communication interface 54 communicates information between the computer 50 and various devices via a network 91.

The medium interface 55 performs communication of information with various media such as a CD, a USB memory, an SD card, a DVD, and Blu-ray.

The input/output device 56 inputs information to the computer 50 and outputs information from the computer 50 to an external device. For example, the input/output device 56 may output information to an external console 58.

The external console 58 is an input and/or output device connected directly or remotely to the computer 50. The external console 58 is, for example, a keyboard, a mouse, or a display.

The external storage medium 57 is a storage medium disposed outside the computer, and is communicably connected to the computer 50. The external storage medium 57 may be disposed on a cloud, for example. The external storage medium 57 may be disposed in the same premises or the like as the computer 50.

### Second Embodiment

The first embodiment described the asset management system configured to extract a related case to which the target asset has been applied, calculate the requirement asset relevance degree indicating the degree of relevance with the target asset for each requirement of the related case, specify, as a related case-related requirement, a requirement of which the requirement-asset relevance degree exceeds a predetermined threshold value, calculate a ratio of the number of related case-related requirements with respect to the number of related case requirements as the case contribution degree, and calculate a business contribution degree indicating a degree of contribution of the target asset to business based on the case contribution degree and the sales of the related case. In contrast, assuming that the value of an asset may decrease with the passage of time, a second embodiment describes an asset management system that calculates a business contribution degree in consideration of the timing of occurrence of a related case to which a target asset has been applied.

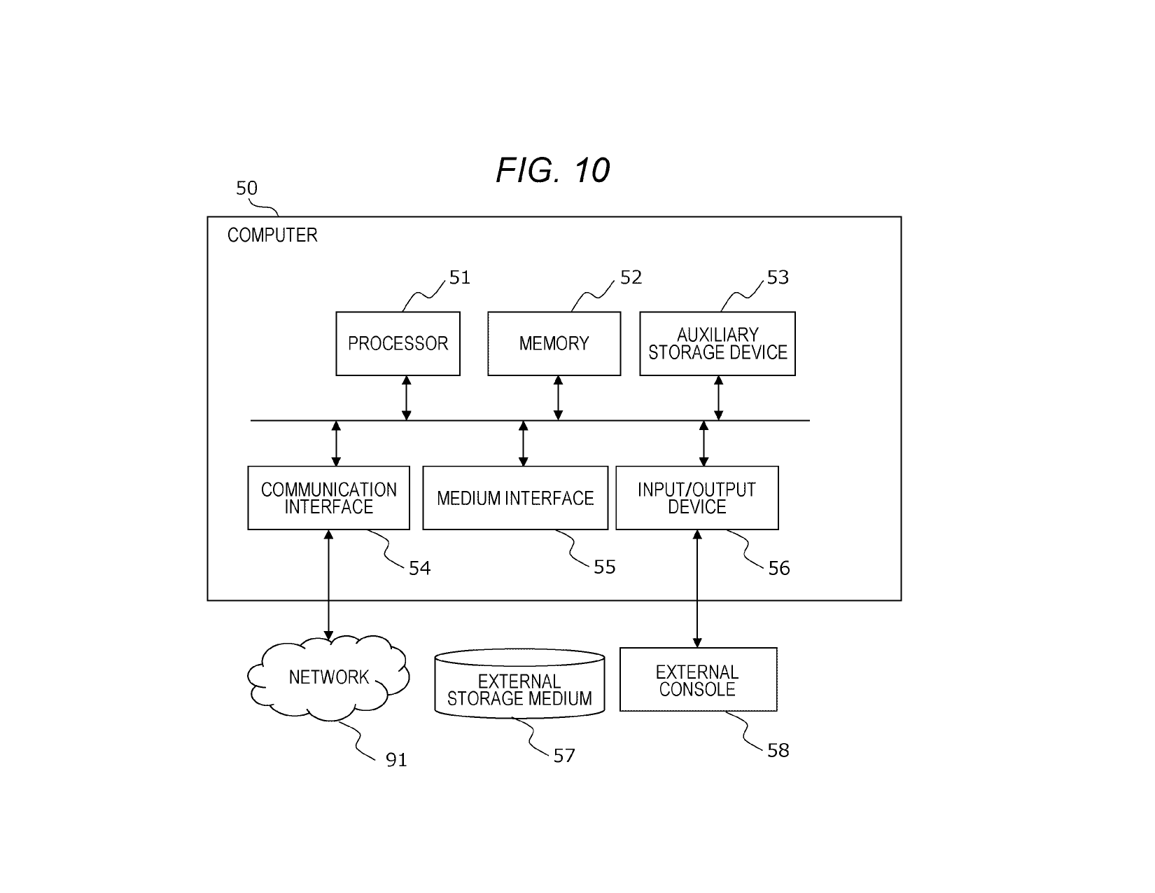

FIG. 11 is a block diagram illustrating a configuration example of the asset management system according to the second embodiment.

An asset management system 1B includes an asset management server 10, a case management server 20B, and an information processing apparatus 30B. The asset management server 10 is similar to that of the first embodiment.

The information processing apparatus 30B includes a processor and a memory like the information processing apparatus 30 of the first embodiment. The processor of the information processing apparatus 30B loads and executes an asset management program from the memory, thereby implementing the functions of a target asset acquisition unit 31, an asset information acquisition unit 32, an RFP reading unit 33, an asset-RFP requirement collation unit 34, an asset contribution degree calculation unit 35, a business contribution degree calculation unit 36B, and a business contribution degree result output unit 37. The target asset acquisition unit 31, the asset information acquisition unit 32, the RFP reading unit 33, the asset-RFP requirement collation unit 34, the asset contribution degree calculation unit 35, and the business contribution degree result output unit 37 are similar to those of the first embodiment. The business contribution degree calculation unit 36B performs different processing from the business contribution degree calculation unit 36 of the first embodiment. The processing of the business contribution degree calculation unit 36B will be described later.

A case management server 20B of the second embodiment is different from that of the first embodiment in that a case table 211B is provided instead of the case table 211.

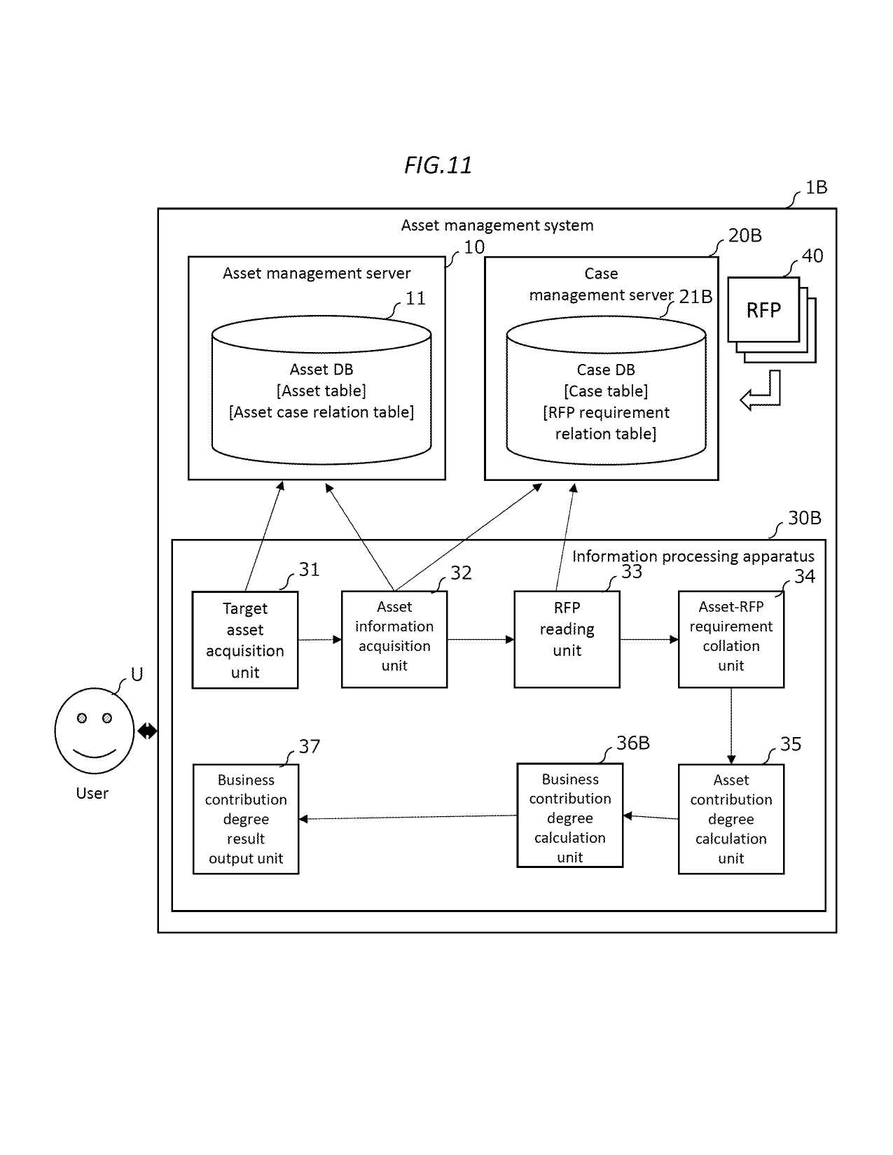

FIG. 12 is a conceptual diagram illustrating a configuration example of the case table according to the second embodiment;

The case table 211B includes, as information items, a case ID, a sales amount, an RFP ID, and a case start date. The case table 211B may include other information items. The case ID, the sales amount, and the RFP ID are similar to those of the first embodiment in FIG. 4. The case start date is date information indicating the start date of the case. For example, a case with a case ID of O0001 indicates that the case has been started on October 31, 2021.

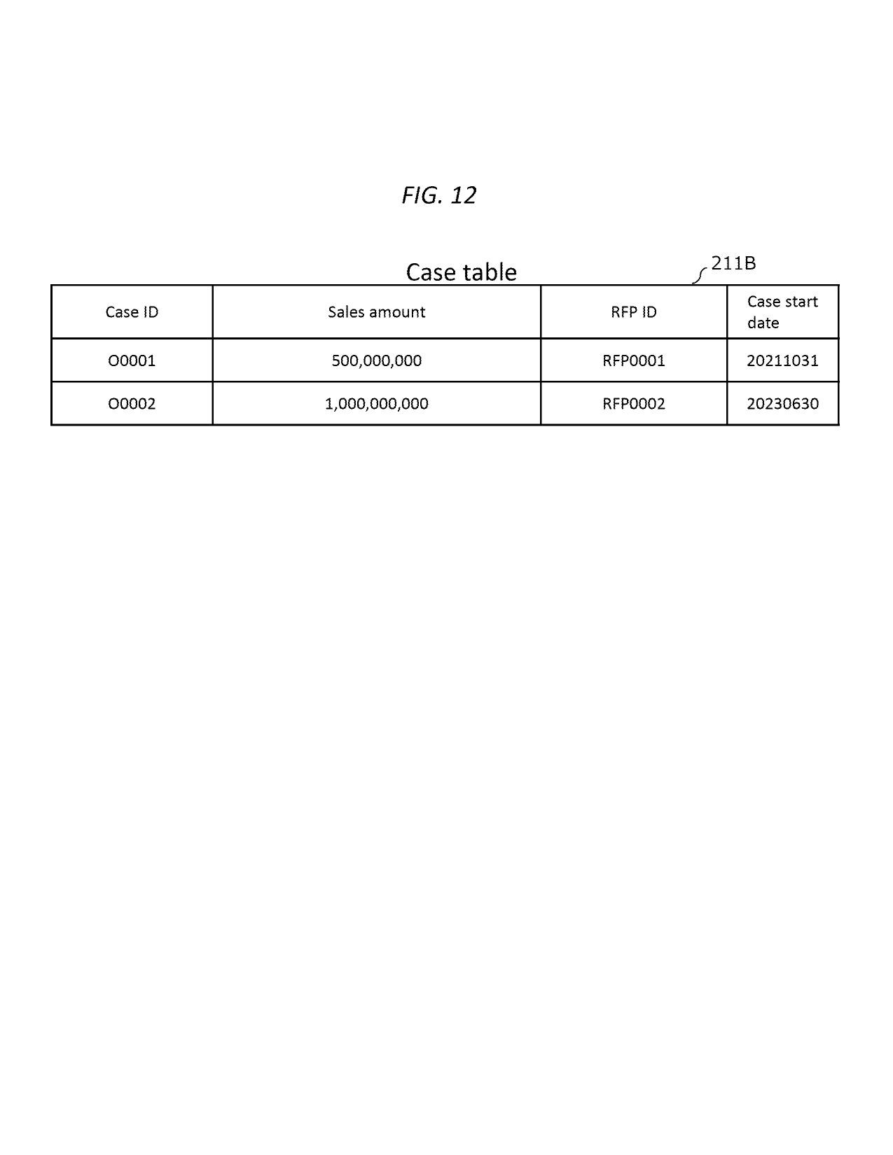

FIG. 13 is a flowchart illustrating output processing of a business contribution degree according to the second embodiment.

The processing of steps St101 to St104 is similar to that of the first embodiment in FIG. 6.

After the case contribution degree of a target asset in each related case is calculated in step St104B, the business contribution degree calculation unit 36B calculates the novelty degree of the target case of the target asset. That is, a novelty degree is calculated for each related case of the target asset. The novelty degree is an index indicating how recently the target asset has been applied to the related case, that is, how short the elapsed time is since the start of the related case.

For example, the novelty degree = 1/(measurement date - case start date) may be set. The measurement date is the current date on which an asset management system 1C is used. The case start date is obtained by referring to the case table 211B shown in FIG. 12. The formula of the novelty degree is merely an example. Any formula may be used if the novelty degree decreases as the difference in the number of days of “measurement date - case start date” increases. As another example, a formula may be set such that cases within three years are considered novel while cases decrease in novelty in inverse proportion to the number of lapsed days after the elapse of three years or more. In this case, for example, the novelty degree = 1/max (1, measurement date - case start date [yearly] - 2) may be set.

In step St103, if it is determined that the case contribution degree of the target asset has been calculated for all the cases on the list (St103:YES), the business contribution degree calculation unit 36B calculates the business contribution degree of the target case in step St105.

### Calculation Algorithm of Business Contribution Degree

The business contribution degree in the second embodiment may be calculated by, for example, a calculation algorithm as follows.

The business contribution degree calculation unit 36B specifies the sales of the related case that is the case realized using the target asset, with reference to the case table 211B, that is, case information. The business contribution degree calculation unit 36B calculates the business contribution degree indicating the degree of contribution to the business by the target asset based on the case contribution degree of the related case and the novelty degree.

The business contribution degree may be calculated, for example, by adding up the product of the case contribution degree, the sales, and the novelty degree for all related cases. That is, the business contribution degree calculation unit 36B sets, as the business contribution degree, the total value of values obtained by multiplications of the case contribution degree, the sales, and the novelty degree for each of the related cases.

After the business contribution degree is calculated, in step St106, the business contribution degree result output unit 37 outputs the business contribution degree of the target asset as in the first embodiment.

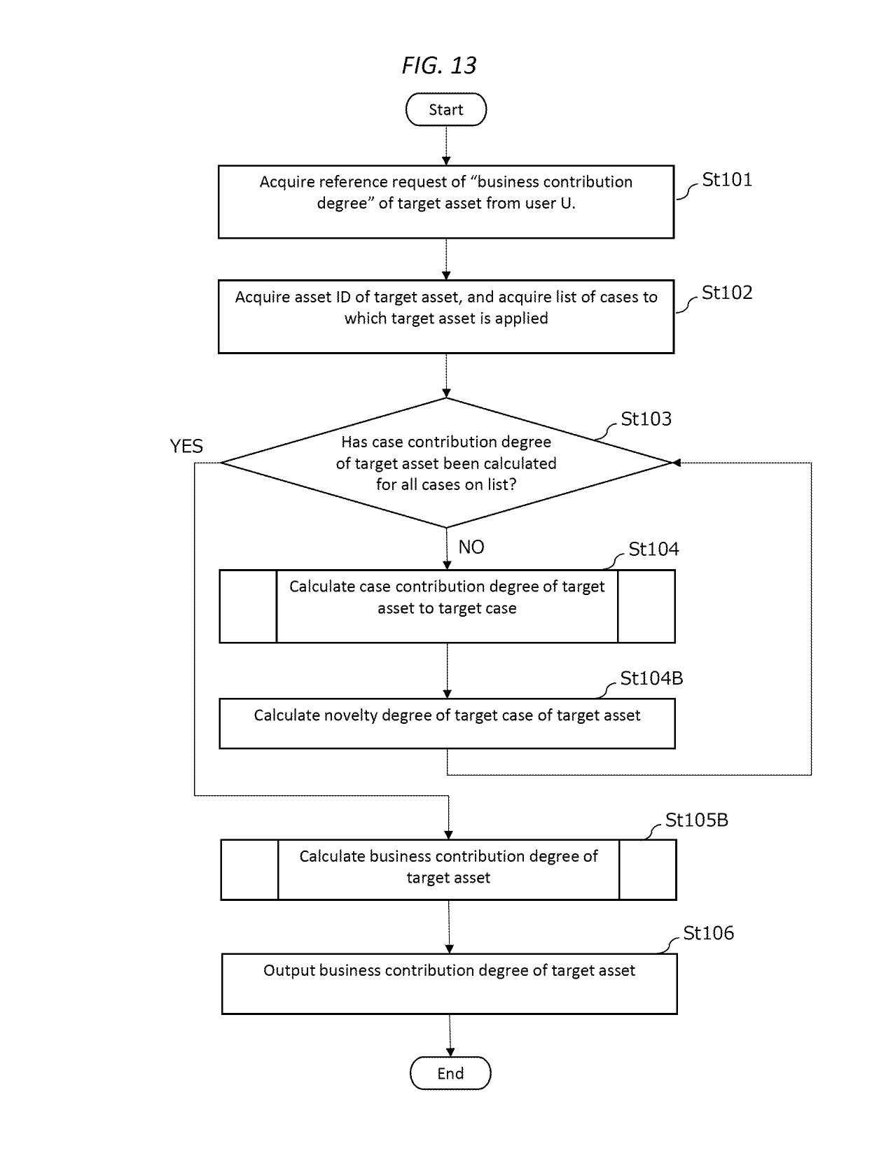

FIG. 14 is a conceptual diagram illustrating an output example of an asset search result (detail) according to the second embodiment. When a user U selects an asset B in the display state of FIG. 8, more detailed search results in FIG. 14 are displayed on a display device D11B.

On the display device D11B, a detailed list L02B of the asset B selected by the user U is displayed. The detailed list L02B includes basic information, detailed information, the latest case start date, and the business contribution degree as information items. The basic information and the detailed information may be information registered in an asset table 111. The latest case start date is the start date of the latest case using the asset. In addition, the novelty degree of the target asset is added to the business contribution degree. The business contribution degree of the asset B may be calculated in advance and stored in the memory of the asset management system 1. The business contribution degree of the asset B may be dynamically calculated when the user U selects the asset B in FIG. 8.

On the display device D11B, a case list L03B using the asset B is displayed. The case list L03B includes an application case, sales, case start date, and the case contribution degree as information items.

As described above, according to the present embodiment, the business contribution degree can be calculated in consideration of the sales amount and the novelty degree of the case, thereby supporting the promotion of use of the registered asset.

### Third Embodiment

In the first and second embodiments, the registration and use of useful assets are promoted by properly evaluating a business contribution degree for each of registered assets. In a third embodiment, an asset management system for evaluating the owner of a registered asset as well as the asset is described. A proper evaluation of an owner can promote the effective use of knowledge of the owner, that is, an expert having useful knowledge and experience for users.

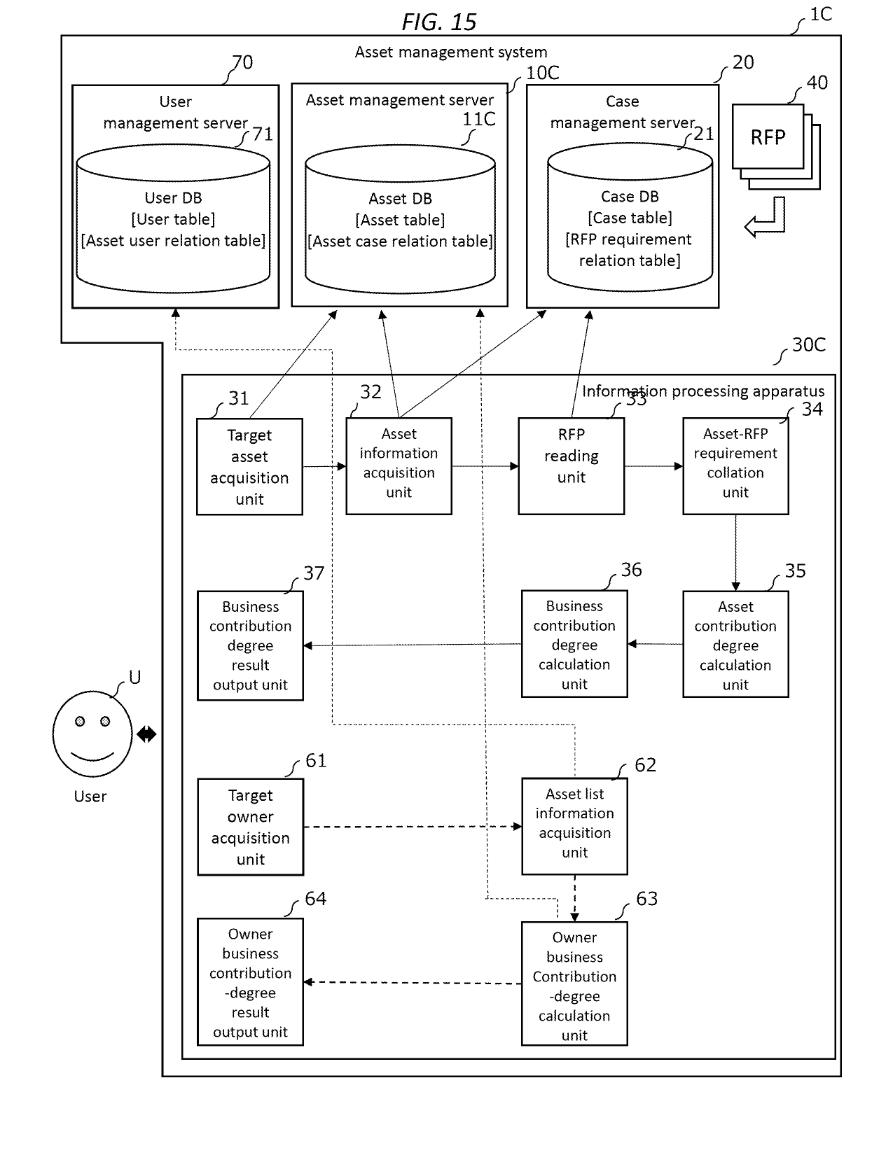

FIG. 15 is a block diagram illustrating a configuration example of the asset management system according to the third embodiment.

An asset management system 1C includes an asset management server 10C, a case management server 20, a user management server 70, and an information processing apparatus 30C. The case management server 20 is similar to that of the first embodiment.

The asset management server 10C of the third embodiment is different from that of the first embodiment in that an asset table 111C is provided instead of the asset table 111 in an asset database 11C.

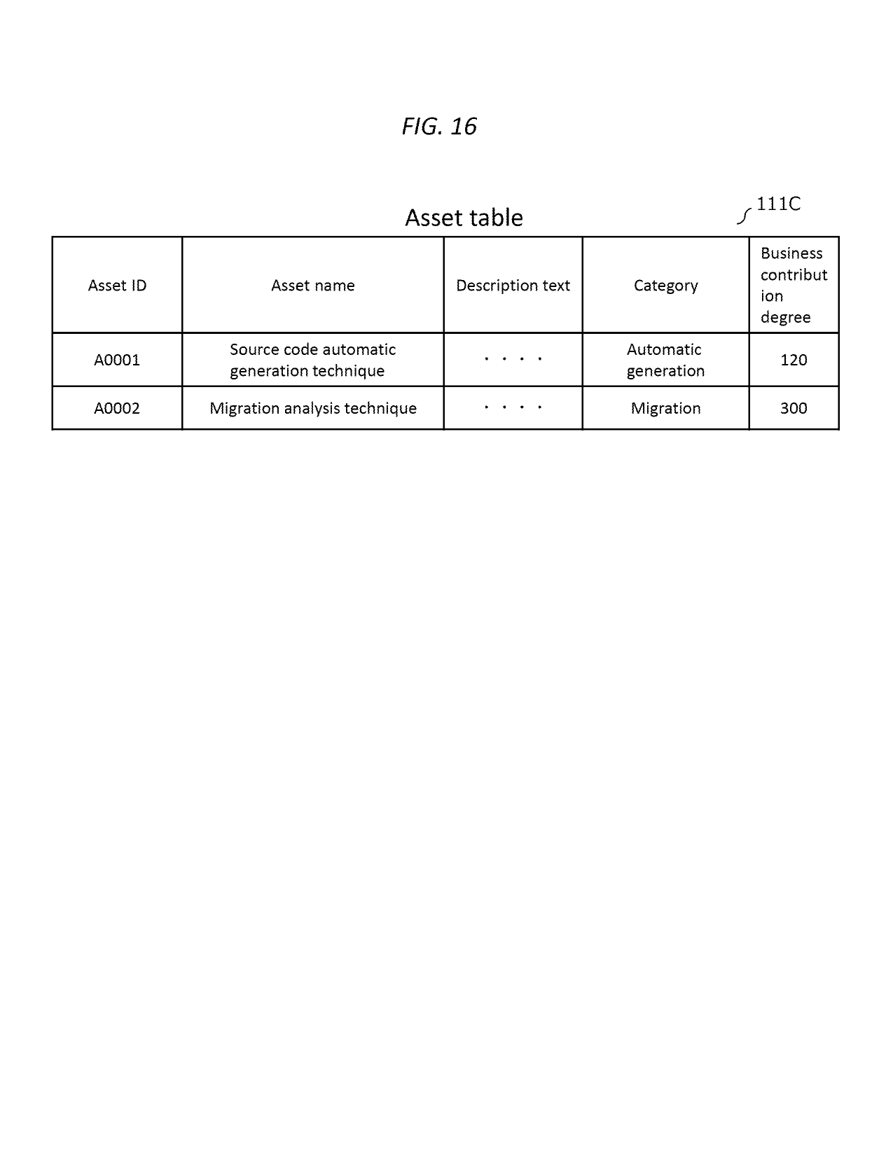

FIG. 16 is a conceptual diagram illustrating a configuration example of the asset table according to the third embodiment.

The asset table 111C includes, as information items (columns), an asset ID, an asset name, a description text, and a business contribution degree. The asset ID, the asset name, the description text, and the business contribution degree are similar to those of the first embodiment in FIG. 2. The business contribution degree may be calculated by adding the novelty degree of the asset according to the method of the second embodiment.

The category is the classification of an asset. In the example of FIG. 16, a processing category is show to indicate the type of processing to which the asset is applied, for example, “automatic generation” or “migration”. However, the category is not limited to this processing category. As another example, the category may be a technique category (e.g., cloud, network, or security) or a business category (e.g., finance, industry, or a public sector). The category is entered by a user to register the asset (that is, the owner of the asset).

The user management server 70 includes a processor and a memory like the case management server 20. The memory stores a user DB 71. The user DB 71 includes a user table and an RFP requirement relation table.

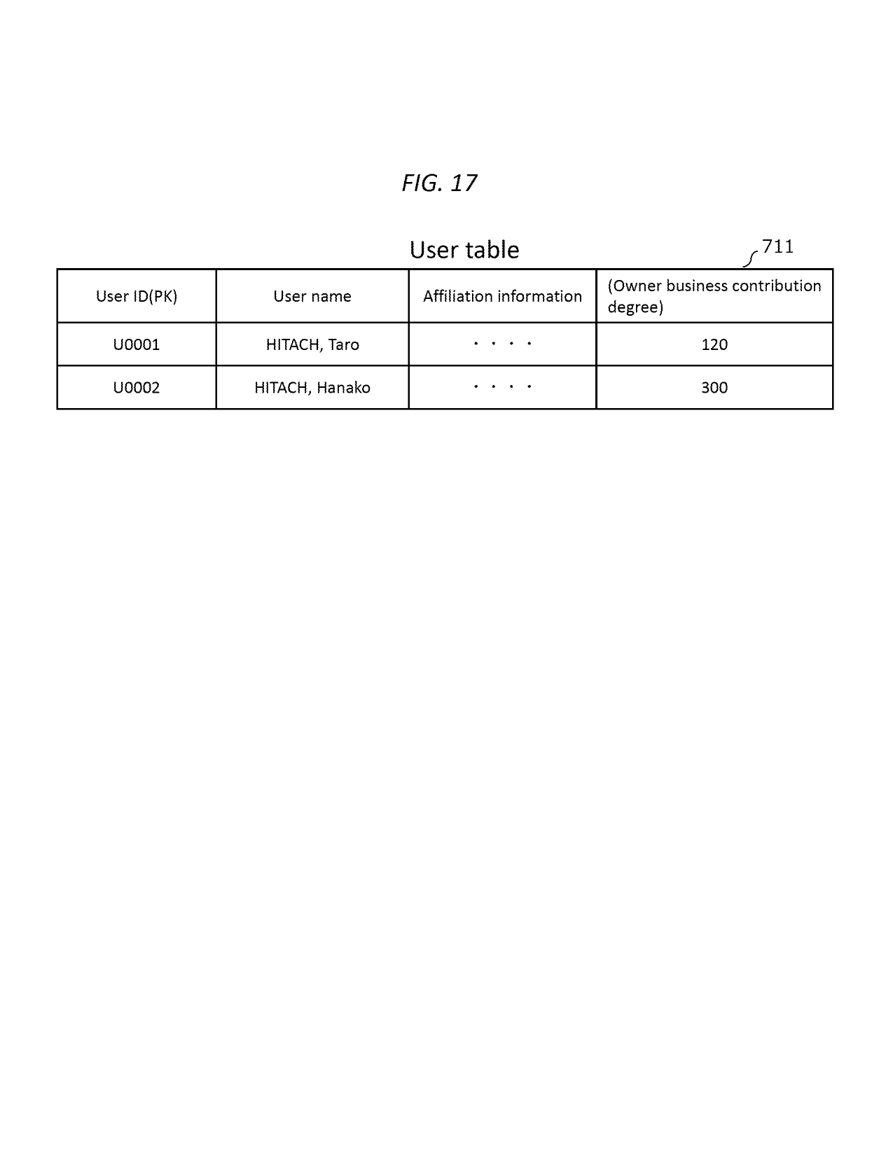

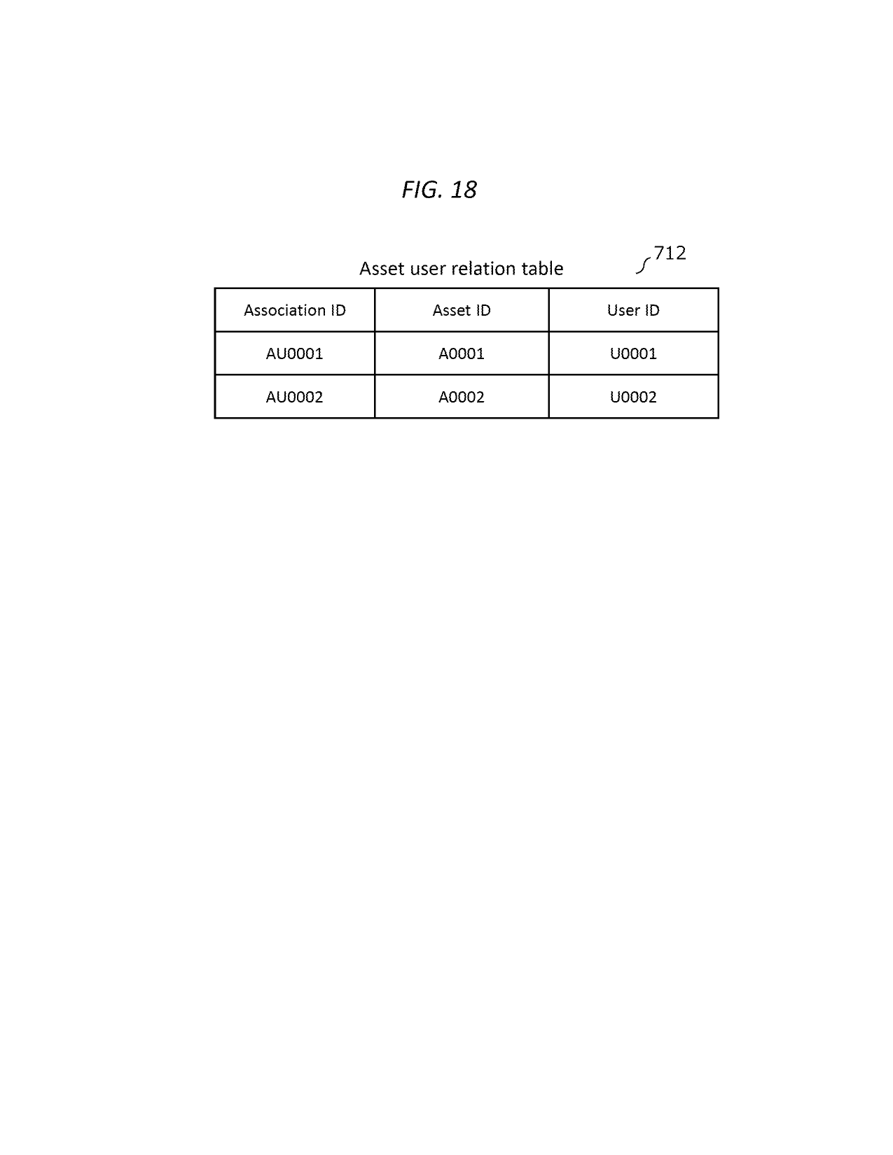

FIG. 17 is a conceptual diagram illustrating a configuration example of the user table according to the third embodiment. FIG. 18 is a conceptual diagram illustrating a configuration example of an asset user relation table according to the third embodiment.

A user table 711 includes, as information items, a user ID, a user name, affiliation information, and an owner business contribution degree. The user table 711 may include other information items. Information about a user having registered an asset, that is, an owner is registered in the user table 711. Furthermore, information indicating, instead of the owner, an integrator using the asset management system 1C may be registered in the user table 711.

The user ID is an identifier that can uniquely identify a user. The user name is the name of the user. The affiliation information is information indicating an organization or a department to which the user belongs. The owner business contribution degree is an index indicating the degree of contribution to business by the user serving as an asset owner. The owner business contribution degree is registered in the user table 711 after being calculated by a method described later.

An asset user relation table 712 includes, as information items, an association ID, an asset ID, and a user ID. The asset user relation table 712 may include other information items. The association ID is an identifier that can uniquely identify an association between an asset and a user having registered the asset. The asset ID is an identifier that can uniquely identify an asset and corresponds to an asset ID in the asset table 111C. The user ID is an identifier that can uniquely identify the user and corresponds to a user ID in the user table 711.

The processor of the information processing apparatus 30C of the third embodiment loads and executes an asset management program from the memory, thereby implementing the functions of a target asset acquisition unit 31, an asset information acquisition unit 32, an RFP reading unit 33, an asset-RFP requirement collation unit 34, an asset contribution degree calculation unit 35, a business contribution degree calculation unit 36, a business contribution degree result output unit 37, a target owner acquisition unit 61, an asset list information acquisition unit 62, an owner business-contribution-degree calculation unit 63, and an owner business-contribution-degree result output unit 64.

The target asset acquisition unit 31, the asset information acquisition unit 32, the RFP reading unit 33, the asset-RFP requirement collation unit 34, the asset contribution degree calculation unit 35, the business contribution degree calculation unit 36, and the business contribution degree result output unit 37 are similar to those of the first embodiment. Processing with the target owner acquisition unit 61 the asset list information acquisition unit 62, the owner business-contribution-degree calculation unit 63, and the owner business-contribution-degree result output unit 64 will be described later.

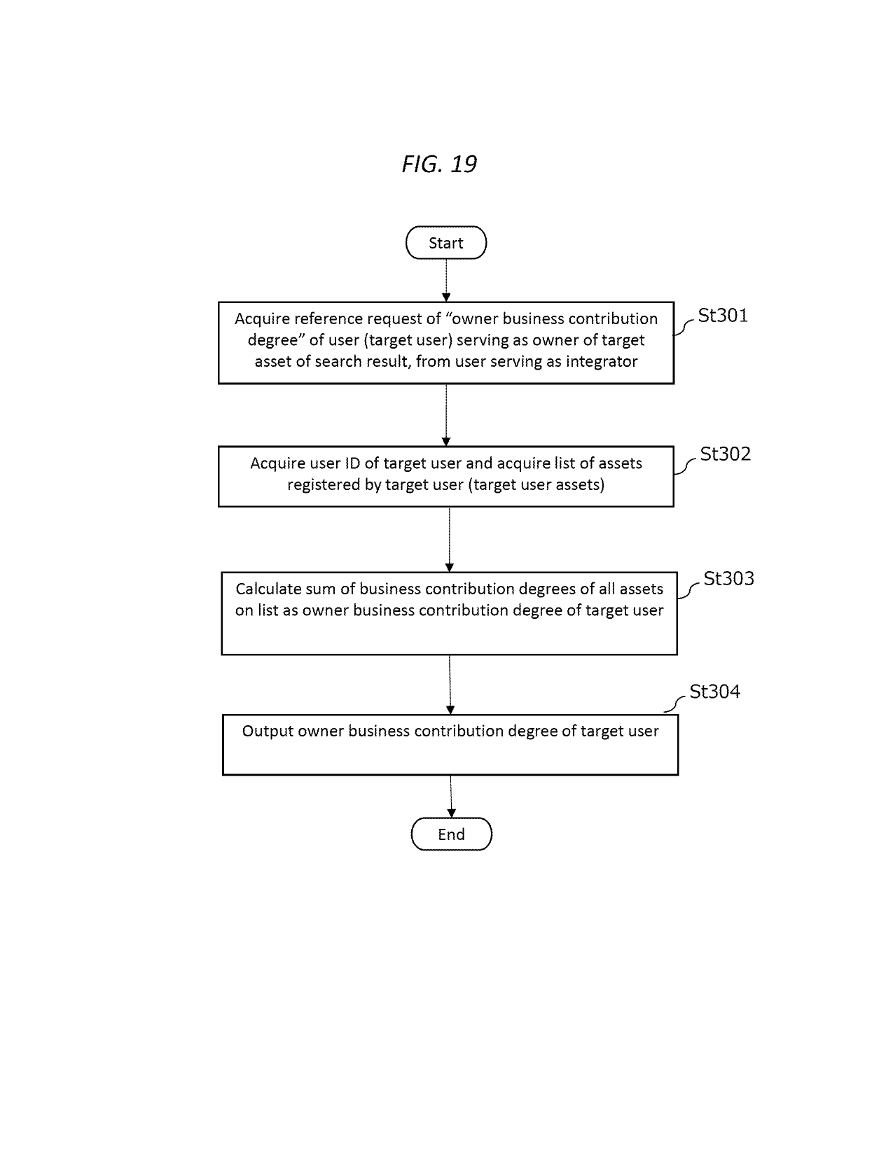

FIG. 19 is a flowchart illustrating output processing of an owner business contribution degree according to the third embodiment.

The information processing apparatus 30C acquires a reference request of “owner business contribution degree” of the user (target user) serving as the owner of the target asset of a search result, from a user U serving as an integrator (St301). The target owner acquisition unit 61 acquires, as a target user, a user having received a request from the user U.

In step St302, the asset list information acquisition unit 62 of the information processing apparatus 30C refers to the user table 711 to acquire the user ID of the target user and refers to the asset user relation table 712 to acquire a list of assets registered by the target user (target user assets). Next, in step St303, the owner business-contribution-degree calculation unit 63 of the information processing apparatus 30C calculates the sum of the business contribution degrees of all the assets on the list as the owner business contribution degree of the target user. Thereafter, in step St304, the owner business-contribution-degree result output unit 64 of the information processing apparatus 30C outputs the owner business contribution degree of the target user.

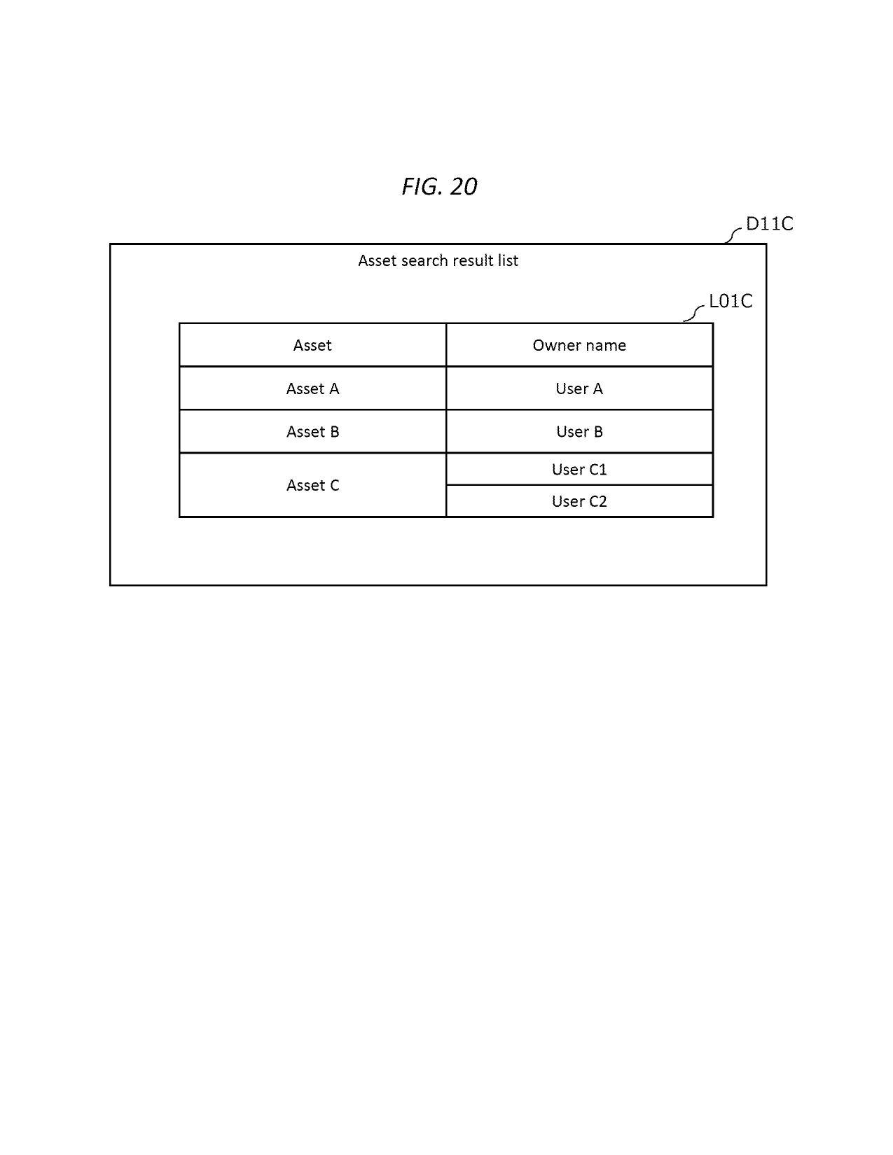

FIG. 20 is a conceptual diagram illustrating an output example of an asset search result according to the third embodiment.

As described in the first embodiment, the user U first transmits a reference request of “business contribution degree” of the target asset to the asset management system 1C via a computer such as a user terminal. As a result, an asset search result is output to a display device D11C included in a computer such as a user terminal.

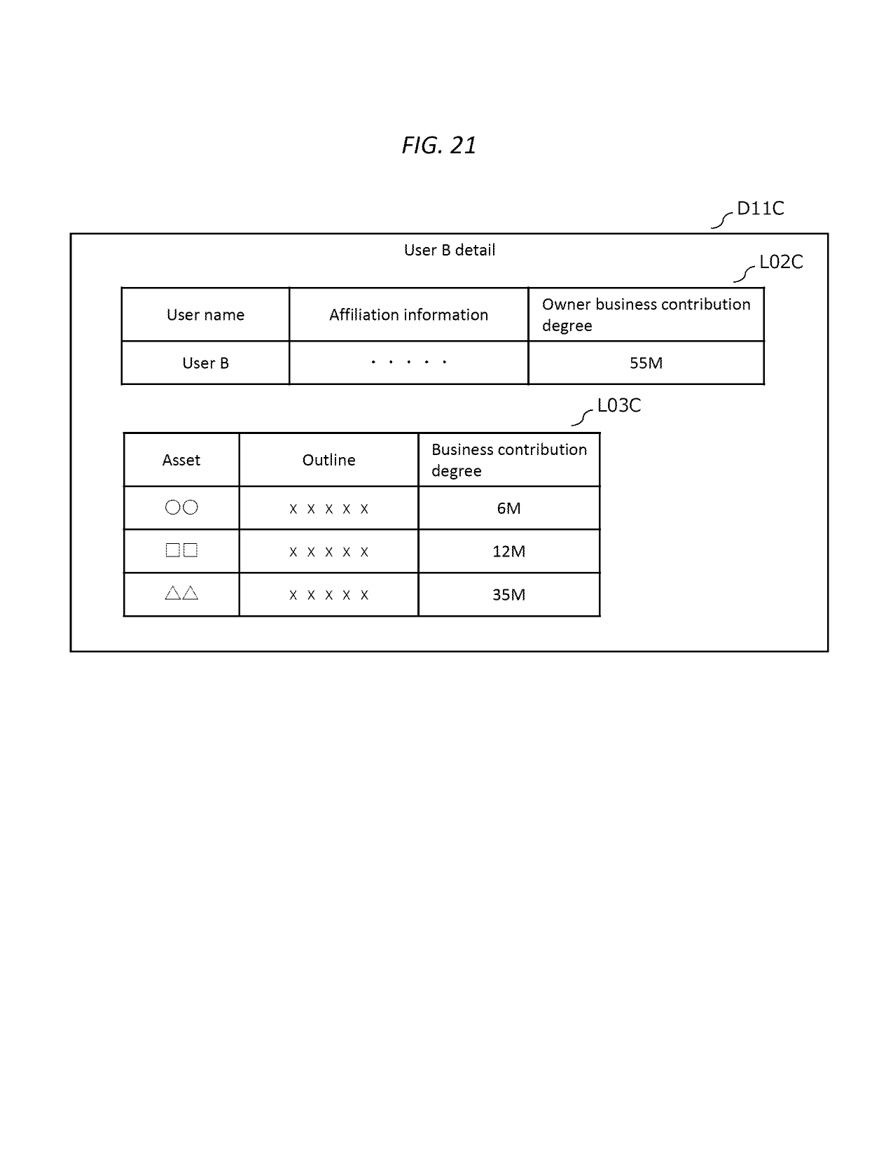

A list L01C is displayed as an asset search result on the display device D11C. The asset table is searched by an asset name or a description text, and the corresponding asset and the owner name of the user having registered the asset are associated with each other in the list. When the user U selects the area of an owner name with a tap, the owner name being displayed in the list L01C, the screen transitions to a display screen in FIG. 21.

FIG. 21 is a conceptual diagram illustrating an output example of an asset search result (detail) according to the third embodiment.

When the user U selects a user B in the display state of FIG. 20, more detailed search results in FIG. 21 are displayed on a display device D11C.

On the display device D11C, a detailed list L02C of the user B selected by the user U is displayed. The detailed list L02C includes a user name, affiliation information, and an owner business contribution degree as information items. The user name and the affiliation information may be information registered in the user table 711. The owner business contribution degree of the user B may be calculated in advance and stored in the memory of the asset management system 1C. The owner business contribution degree of the user B may be dynamically calculated when the user U selects the user B in FIG. 20.

On the display device D11C, an asset list L03C of assets selected by the user B is displayed. The asset list L03C includes an asset, an outline, and a business contribution degree as information items. The asset is, for example, an asset name registered in the asset table 111. The outline is, for example, a description text registered in the asset table 111. The business contribution degree is, for example, a business contribution degree registered in the asset table 111.

As described above, according to the present embodiment, the contribution degree of the user can be evaluated in addition to the asset, thereby supporting the promotion of use of the asset and the knowledge of the user.

Furthermore, the information processing apparatus 30C of the present embodiment may calculate an owner business contribution degree for each category. In this case, for example, in step St303, the owner business-contribution-degree calculation unit 63 of the information processing apparatus 30C may classify assets on the list by categories registered in the asset table 111 and calculate the sum of the business contribution degrees of assets for each category as an owner business contribution degree for each category. Thus, an owner business contribution degree for each category can be calculated and used.

In addition, the information processing apparatus 30C of the present embodiment may accept designation of a category from the user U and calculate the sum of the business contribution degrees of assets that belong to the designated category. Thus, an owner business contribution degree for the designated category can be calculated and used.

The above-described embodiment of the present invention is an example for describing the present invention, and is not intended to limit the scope of the present invention only to that embodiment. A person skilled in the art can implement the present invention in various other aspects without departing from the scope of the present invention.

The above-described embodiment includes the following items. However, the matters included in the embodiment are not limited to those described below.

### Item 1

An asset management system including:

a memory; and a processor,

in which the memory stores

asset case relation information in which each registered asset is associated with a case realized using the asset, and

case information in which sales are recorded for each of the cases, and

the processor is configured to:

set any one asset as a target asset;

extract, for the target asset, a related case that is a case realized using the target asset with reference to the asset case relation information;

calculate, for the target asset, a case contribution degree indicating a degree of contribution of the target asset in each of the related cases; and

specify sales of the related case with reference to the case information, and calculate a business contribution degree indicating a degree of contribution of the target asset with respect to business based on the case contribution degree and the sales of the related case.

As a result, since the asset is evaluated by integrating the degree of contribution in the past cases, it is possible to support promotion of use of the registered asset.

### Item 2

The asset management system described in Item 1, in which

the memory stores

asset information in which an asset description text describing the asset by text is recorded for each of the assets, and

requirement-related information in which each requirement included in each case-related document of the case is associated with a requirement description text describing the requirement by text in the case-related document, and

the processor is further configured to:

extract a related case requirement that is a requirement included in a case-related document of the related case, by referring to the requirement-related information;

calculate a requirement asset relevance degree indicating a degree of relevance between a case and an asset by referring to the asset information and the requirement-related information, based on a similarity degree between a requirement description text of each of the related case requirements and an asset description text of the target asset for each of the related case requirements;

specify, as a related case-related requirement, a requirement of which the requirement-asset relevance degree exceeds a predetermined threshold value among the related case requirements; and

calculate a case contribution degree of the related case in consideration of the related case-related requirement among the related case requirements.

As a result, it is possible to calculate a detailed case contribution degree in consideration of the requirement asset relevance degree.

### Item 3

The asset management system described in Item 2, in which

the processor is further configured to: calculate a ratio of the number of the related case-related requirements with respect to the number of the related case requirements as the case contribution degree.

As a result, the processor can calculate the case contribution degree in such a manner that the case contribution degree increases as the number of requirements having the requirement asset relevance degree that is higher than the threshold value becomes more.

### Item 4

The asset management system described in Item 2, in which

the requirement-related information further associates each requirement included in each case-related document of the case with an evaluation value indicating evaluation for the requirement, and

the processor is further configured to: calculate the case contribution degree in consideration of the related case requirement and an evaluation value of the related case requirement, and the related case-related requirement and an evaluation value of the related case-related requirement, with reference to the requirement-related information.

As a result, it is possible to calculate a more detailed case contribution degree in consideration of not only the requirement asset relevance degree but also the evaluation value for the requirement.

### Item 5

The asset management system described in Item 4, in which

the processor is further configured to: calculate a ratio of a total value of the evaluation values of the related case-related requirements with respect to a total value of the evaluation values of the related case requirements, as the case contribution degree.

As a result, the processor can calculate the case contribution degree in consideration of not only the number of related case-related requirements with respect to the number of related case requirements but also the magnitude of the evaluation value for each requirement.

### Item 6

The asset management system described in Item 1, in which

the processor is further configured to set, as the business contribution degree, a total value of values obtained by multiplying case contribution degrees of the respective related cases by sales.

As a result, the processor can calculate the business contribution degree in consideration of not only the simple case contribution degree but also the magnitude of sales.

### Item 7

The asset management system described in Item 1, in which

the memory stores the asset information that enables word search for an asset name and a description text of each registered asset with one or both of the asset name and the description text, and

the processor is further configured to: present, to a user, a list of assets corresponding to a word designated by the user from the asset information.

As a result, the processor can select an asset that the user wants to check and provide information to the user.

### Item 8

The asset management system described in Item 1, in which

the processor is further configured to:

receive a user operation of designating an asset and requesting reference to information of the designated asset, calculate a business contribution degree of the target asset, and present the business contribution degree to a user.

As a result, it is possible to calculate and present the latest contribution degree based on the registered latest information.

### Item 9

The asset management system described in Item 1, in which

the processor is further configured to:

calculate a business contribution degree of each registered asset in advance and record the business contribution degree in the memory; and

receive a user operation of designating an asset and requesting reference to information of the designated asset, read a business contribution degree of the target asset from the memory, and present the business contribution degree to a user.

As a result, it is possible to quickly present the contribution degree with respect to the request for reference by the user.

### Item 10

The asset management system described in Item 2, in which the case-related document is a proposal request form, and

the processor is configured to extract a requirement and a requirement description text describing the requirement from the proposal request form, and register the requirement and the requirement description text in association with each other in the requirement-related information.

As a result, the system can read the content described in the proposal request form and register information necessary for calculating the business contribution degree in the memory.

### Item 11

The asset management system described in Item 1, in which the processor is configured to set, as the business contribution degree, the total value of values obtained by multiplications of the case contribution degree, the sales, and the novelty degree for each of the related cases, the novelty degree indicating how short the elapsed time is since the start of the related case.

As a result, the processor can calculate the business contribution degree in consideration of not only simply the case contribution degree but also the magnitude of the sales amount and the novelty degree of the case.

### Item 12

The asset management system described in Item 1, in which the memory stores asset-user related information in which the asset and a user having registered the asset,

the processor is configured to:

set any one of users as a target user,

refer to the asset-user related information to extract, for the target user, a target user asset, which serves as an asset registered by the target user as an owner, and

calculate an owner business contribution degree on the basis of the business contribution degree of the target user asset, the owner business contribution degree indicating the degree of contribution to business by the target user serving an asset owner.

As a result, the owner having registered the asset is evaluated by integrating the degrees of contribution in the past cases, thereby supporting promotion of use and registration of assets.

### Item 13

The asset management system described in Item 12, in which the processor is configured to calculate the sum of the business contribution degrees of the target user assets as the owner business contribution degree.

As a result, the processor can calculate the owner business contribution degree of the user from the business contribution degree registered by the user.

### Item 14

The asset management system described in Item 12, in which the memory further stores asset information, in which a category for classifying the assets is recorded, for each of the assets, and

the processor configured to classify the target user assets by the category and calculate the sum of the business contribution degrees of the target user asset as an owner business contribution degree for each category.

As a result, the processor can calculate and use, for each category, an owner business contribution degree.

### Item 15

The asset management system described in Item 12, in which the memory further stores asset information, in which a category for classifying the assets is recorded, for each of the assets, and

the processor configured to calculate, among the target user assets, the sum of the business contribution degrees of the target user assets as a designated-category owner business contribution degree, the target user assets belonging to the designated category.

As a result, the processor can calculate and use the owner business contribution degree of the designated category.

### Item 16

An asset management method performed by an asset management system including a memory and a processor, in which

the memory stores

asset case relation information in which each registered asset is associated with a case realized using the asset, and

case information in which sales are recorded for each of the cases, and

in a case where any one asset is set as a target asset, the processor is configured to:

extract, for the target asset, a related case that is a case realized using the target asset with reference to the asset case relation information;

calculate, for the target asset, a case contribution degree indicating a degree of contribution of the target asset in each of the related cases; and

specify sales of the related case with reference to the case information, and calculate a business contribution degree indicating a degree of contribution of the target asset with respect to business based on the case contribution degree and the sales of the related case.

As a result, since the asset is evaluated by integrating the degree of contribution in the past cases, it is possible to support promotion of use of the registered asset.

What is claimed is:

1. An asset management system comprising:
a memory; and
a processor,
wherein the memory stores
asset case relation information in which each registered asset is associated with a case realized using the asset, and
case information in which sales are recorded for each of the cases, and
the processor is configured to:
set any one asset as a target asset;
extract, for the target asset, a related case that is a case realized using the target asset with reference to the asset case relation information;
calculate, for the target asset, a case contribution degree indicating a degree of contribution of the target asset in each of the related cases; and
specify sales of the related case with reference to the case information, and calculate a business contribution degree indicating a degree of contribution of the target asset with respect to business based on the case contribution degree and the sales of the related case.

2. The asset management system according to claim 1, wherein
the memory stores
asset information in which an asset description text describing the asset by text is recorded for each of the assets, and
requirement-related information in which each requirement included in each case-related document of the case is associated with a requirement description text describing the requirement by text in the case-related document, and
the processor is further configured to:
extract a related case requirement that is a requirement included in a case-related document of the related case, by referring to the requirement-related information;
calculate a requirement asset relevance degree indicating a degree of relevance between a case and an asset by referring to the asset information and the requirement-related information, based on a similarity degree between a requirement description text of each of the related case requirements and an asset description text of the target asset for each of the related case requirements;
specify, as a related case-related requirement, a requirement of which the requirement-asset relevance degree exceeds a predetermined threshold value among the related case requirements; and
calculate a case contribution degree of the related case in consideration of the related case-related requirement among the related case requirements.

3. The asset management system according to claim 2, wherein the processor is further configured to: calculate a ratio of the number of the related case-related requirements with respect to the number of the related case requirements as the case contribution degree.

4. The asset management system according to claim 2, wherein
the requirement-related information further associates each requirement included in each case-related document of the case with an evaluation value indicating evaluation for the requirement, and
the processor is further configured to: calculate the case contribution degree in consideration of the related case requirement and an evaluation value of the related case requirement, and the related case-related requirement and an evaluation value of the related case-related requirement, with reference to the requirement-related information.

5. The asset management system according to claim 4, wherein the processor is further configured to: calculate a ratio of a total value of the evaluation values of the related case-related requirements with respect to a total value of the evaluation values of the related case requirements, as the case contribution degree.

6. The asset management system according to claim 1, wherein the processor is further configured to set, as the business contribution degree, a total value of values obtained by multiplying case contribution degrees of the respective related cases by sales.

7. The asset management system according to claim 1, wherein
the memory stores asset information that enables word search for an asset name and a description text of each registered asset with one or both of the asset name and the description text, and
the processor is further configured to: present, to a user, a list of assets corresponding to a word designated by the user from the asset information.

8. The asset management system according to claim 1, wherein the processor is further configured to receive a user operation of designating an asset and requesting reference to information of the designated asset, calculate a business contribution degree of the target asset, and present the business contribution degree to a user.

9. The asset management system according to claim 1, wherein
the processor is further configured to:
calculate a business contribution degree of each registered asset in advance and record the business contribution degree in the memory; and
receive a user operation of designating an asset and requesting reference to information of the designated asset, read a business contribution degree of the target asset from the memory, and present the business contribution degree to a user.

10. The asset management system according to claim 2, wherein
the case-related document is a proposal request form, and
the processor is further configured to: extract a requirement and a requirement description text describing the requirement from the proposal request form, and register the requirement and the requirement description text in the requirement-related information in association with each other.

11. The asset management system according to claim 1, wherein the processor is configured to set, as the business contribution degree, a total value of values obtained by multiplications of a case contribution degree, sales, and a novelty degree for each of the related cases, the novelty degree indicating how short an elapsed time since the start of the related case.

12. The asset management system according to claim 1, wherein
the memory stores asset-user related information in which the asset and a user having registered the asset are associated with each other, and
the processor is configured to:
set any one of users as a target user,
refer to the asset-user related information to extract, for the target user, a target user asset, which serves as an asset registered by the target user as an owner, and
calculate an owner business contribution degree on a basis of a business contribution degree of the target user asset, the owner business contribution degree indicating a degree of contribution to business by the target user serving an asset owner.

13. The asset management system according to claim 12, wherein the processor is configured to calculate a sum of the business contribution degrees of the target user assets as the owner business contribution degree.

14. The asset management system according to claim 12, wherein the memory further stores asset information, in which a category for classifying the assets is recorded, for each of the assets, and
the processor is configured to classify the target user assets by the category and calculate a sum of business contribution degrees of the target user asset as an owner business contribution degree for each category.

15. The asset management system according to claim 12, wherein the memory further stores asset information, in which a category for classifying the assets is recorded, for each of the assets, and
the processor is configured to calculate, among the target user assets, a sum of the business contribution degrees of the target user assets as a designated-category owner business contribution degree, the target user assets belonging to the designated category.

16. An asset management method performed by an asset management system including a memory and a processor, wherein
the memory stores
asset case relation information in which each registered asset is associated with a case realized using the asset, and
case information in which sales are recorded for each of the cases, and
in a case where any one asset is set as a target asset, the processor is configured to:
extract, for the target asset, a related case that is a case realized using the target asset with reference to the asset case relation information;
calculate, for the target asset, a case contribution degree indicating a degree of contribution of the target asset in each of the related cases; and
specify sales of the related case with reference to the case information, and calculate a business contribution degree indicating a degree of contribution of the target asset with respect to business based on the case contribution degree and the sales of the related case.
